(19) United States
(12) Patent Application Publication
(10) Pub. No.: US 2016/0281498 A1
(43) Pub. Date: Sep. 29, 2016

(54) METHODS FOR OBTAINING DATA FROM A SUBTERRANEAN FORMATION

(71) Applicant: HALLIBURTON ENERGY SERVICES, INC., Houston, TX (US)

(72) Inventors: Philip D. Nguyen, Houston, TX (US); Ronald G. Dusterhoft, Katy, TX (US)

(21) Appl. No.: 15/035,409

(22) PCT Filed: Feb. 18, 2014
(86) PCT No.: PCT/US2014/016914

§ 371 Date: May 9, 2016

(51) Int. Cl. E21B 49/00; C09K 8/80; G01V 3/20; G01V 3/30; E21B 43/26; E21B 43/267

(52) U.S. Cl. CPC E21B 49/00; E21B 43/26; E21B 43/267; G01V 3/20; G01V 3/30; C09K 8/805; C09K 8/80

(57) ABSTRACT

Various embodiments disclosed relate to methods of obtaining data from a subterranean formation and systems for performing the method. In various embodiments, the present invention provides a method of obtaining data from a subterranean formation including obtaining or providing first proppant particles and second proppant particles. The first proppant particles can have a particle size of about 0.2 mm to about 10 mm. The second proppant particles can have a particle size of about 0.010 μm to about 199 μm. The method can include placing the first and second proppant particles into a subterranean formation. In the subterranean formation, at least part of at least one of the first and second proppant particles can be electroconductive proppant particles. The method can include transmitting at least one of an electric current and an electromagnetic signal to at least part of the electroconductive proppant particles. The method can also include detecting at least one of an electric current and an electromagnetic signal at least partially reflected by or conducted through the electroconductive proppant particles.

### BACKGROUND OF THE INVENTION

Hydraulic fracturing is a widely-used process for improving well productivity by placing or enhancing cracks or channels from a well bore a surrounding reservoir. This operation can include injecting a fracturing fluid into a well bore penetrating a subterranean formation at a pressure sufficient to create a fracture in the formation or to enhance a natural fracture in the formation. Proppant particulates can be placed in the fracture to prevent the fracture from closing once the pressure is released. Upon placement, the proppant particulates can form proppant packs in or near desired fractures. These proppant packs, can maintain the integrity of the fractures to create conductive paths to the well bore for desirable fluids to flow.

The geometry of a hydraulic fracture affects the efficiency of the process and the success of a fracturing operation. However, although tiltmeters and other direct methods (e.g., micro seismic measurements) have been used to determine fracture geometry, historically, fracture geometry is more commonly estimated by interpreting measured data and applying mathematical models of fracture growth. This analysis has been generally limited to data from indirect measurements (e.g., flow rate, pressure, temperature, etc.) taken from the wellbores during the fracture treatments. These measurements, however, are heavily influenced by wellbore effects, such as fluid rheology, fluid density, and fluid friction in the wellbore, and generally are not a reliable means of determining some fracture parameters. Fracture conditions, such as the integrity of the proppant pack over time and flow rates through various portions of the fracture pack, cannot be effectively monitored using these wellbore measurements.

### SUMMARY OF THE INVENTION

In various embodiments, the present method provides a method of obtaining data from a subterranean formation. The method includes obtaining or providing first proppant particles and second proppant particles. The first proppant particles have a particle size of about 0.2 mm to about 10 mm. The second proppant particles have a particle size of about 0.010 μm to about 199 μm. The method includes placing the first and second proppant particles into a subterranean formation. In the subterranean formation, at least part of at least one of the first and second proppant particles include electroconductive proppant particles. The method includes transmitting at least one of an electric current and an electromagnetic signal to at least part of the electroconductive proppant particles. The method also includes detecting at least one of an electric current and an electromagnetic signal at least partially reflected by or conducted through at least some of the electroconductive proppant particles.

In various embodiments, the present invention provides a method of obtaining data from a subterranean formation. The method includes obtaining or providing first proppant particles and second proppant particles. The first proppant particles have a particle size of about 0.2 mm to about 10 mm. The second proppant particles have a particle size of about 0.010 μm to about 199 μm. The method includes placing the first and second proppant particles into a fracture network in a subterranean formation. The first proppant particles are placed in the fracture network in primary fractures or in main fracture branches having a smallest cross-sectional dimension of greater than about 0.2 mm. The second proppant particles are placed in the fracture network in microfractures having a smallest cross-sectional dimension of less than about 200 μm. In the subterranean formation, at least the second proppant particles include electroconductive proppant particles including an electroconductive coating including a resin and an electroconductive material. The method includes transmitting at least one of an electric current and an electromagnetic field to at least part of the electroconductive proppant particles. The method also includes detecting at least one of an electric current and an electromagnetic signal at least partially reflected by or conducted through the electroconductive proppant particles, and using the detected reflected or conducted electric current or electromagnetic signal to determine at least one characteristic of the fracture network or a fracture therein including at least one of height, width, length, fracture orientation, geometry, layout, conductivity, proppant conductivity, and distribution of proppant.

In various embodiments, the present invention provides a system for obtaining data from a subterranean formation. The system includes first proppant particles and second proppant particles. The first proppant particles have a particle size of about 0.2 mm to about 10 mm. The second proppant particles have a particle size of about 0.010 μm to about 199 μm. At least part of at least one of the first and second proppant particles include electroconductive proppant particles. The system includes a subterranean formation including the first and second proppant particles therein. The system includes a transmitter configured to transmit at least one of an electric current and an electromagnetic field into at least part of the electroconductive proppant particles. The system also includes a detector configured to detect at least one of an electric current and an electromagnetic signal at least partially reflected by or conducted through at least some of the electroconductive proppant particles.

Various embodiments of the present invention provide certain advantages over other methods, systems, and apparatus for obtaining data from a subterranean formation, at least some of which are unexpected. For example, in some embodiments, the method can be used to gather a greater amount of information about fracture networks than other methods. In some embodiments, the method can gather information about fracture networks in a more efficient or less costly manner. In some embodiments, the method can be used to gather information about more complex, tighter, and less conventional fracture networks, such as fracture networks including microfractures or high proportions of microfractures, than is possible with other methods. In some embodiments, the method can provide a greater amount of detail about a fracture network than other methods, including over time and during production. In some embodiments, the method can provide information about the location of proppant, the size and location of fractures, or a combination thereof. In some embodiments, the method can include coating a fracture in the subterranean formation with electroconductive material. In some embodiments, the method can advantageously include forming electroconductive proppant in the subterranean formation (e.g., downhole) by applying an electroconductive material to the proppant in the subterranean formation.

In various embodiments, well performance in an unconventional asset with complex fracture systems can be affected by factors including 1) the stimulated volume of rock or the volume of rock that has been connected to the wellbore through the fracturing process; and 2) the connected fracture area within the stimulated volume of rock including fractures and microfractures. In various embodiments, the method can capture data on both of these properties to provide detail on how effectively a reservoir has been stimulated.

### BRIEF DESCRIPTION OF THE FIGURES

The drawings illustrate generally, by way of example, but not by way of limitation, various embodiments discussed in the present document.

FIGS. 1a-b illustrate systems for performing a method for obtaining data from a subterranean formation, in accordance with various embodiments.

FIGS. 2a-d illustrate systems for performing a method for obtaining data from a subterranean formation, in accordance with various embodiments.

FIG. 3 illustrates a system or apparatus for delivering a composition to a subterranean formation, in accordance with various embodiments.

### DETAILED DESCRIPTION OF THE INVENTION

Reference will now be made in detail to certain embodiments of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference should be considered supplementary to that of this document; for irreconcilable inconsistencies, the usage in this document controls.

In the methods of manufacturing described herein, the steps can be carried out in any order without departing from the principles of the invention, except when a temporal or operational sequence is explicitly recited. Furthermore, specified steps can be carried out concurrently unless explicit claim language recites that they be carried out separately. For example, a claimed step of doing X and a claimed step of doing Y can be conducted simultaneously within a single operation, and the resulting process will fall within the literal scope of the claimed process.

Selected substituents within the compounds described herein are present to a recursive degree. In this context, “recursive substituent” means that a substituent may recite another instance of itself or of another substituent that itself recites the first substituent. Recursive substituents are an intended aspect of the disclosed subject matter. Because of the recursive nature of such substituents, theoretically, a large number may be present in any given claim. One of ordinary skill in the art of organic chemistry understands that the total number of such substituents is reasonably limited by the desired properties of the compound intended. Such properties include, by way of example and not limitation, physical properties such as molecular weight, solubility, and practical properties such as ease of synthesis. Recursive substituents can call back on themselves any suitable number of times, such as about 1 time, about 2 times, 3, 4, 5, 6, 7, 8, 9, 10, 15, 20, 30, 50, 100, 200, 300, 400, 500, 750, 1000, 1500, 2000, 3000, 4000, 5000, 10,000, 15,000, 20,000, 30,000, 50,000, 100,000, 200,000, 500,000, 750,000, or about 1,000,000 times or more.

The term “about” as used herein can allow for a degree of variability in a value or range, for example, within 10%, within 5%, or within 1% of a stated value or of a stated limit of a range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more.

The term “organic group” as used herein refers to but is not limited to any carbon-containing functional group. For example, an oxygen-containing group such as an alkoxy group, aryloxy group, aralkyloxy group, oxo(carbonyl) group, a carboxyl group including a carboxylic acid, carboxylate, and a carboxylate ester; a sulfur-containing group such as an alkyl and aryl sulfide group; and other heteroatom-containing groups. Non-limiting examples of organic groups include OR, OOR, OC(O)N(R)₂, CN, CF₃, OCF₃, R, C(O), methylenedioxy, ethylenedioxy, N(R)₂, SR, SOR, SO₂R, SO₂N(R)₂, SO₃R, C(O)R, C(O)C(O)R, C(O)CH₂C(O)R, C(S)R, C(O)OR, OC(O)R, C(O)N(R)₂, OC(O)N(R)₂, C(S)N(R)₂, (CH₂)₀₋₂N(R)C(O)R, (CH₂)₀₋₂N(R)N(R)₂, N(R)N(R)C(O)R, N(R)N(R)C(O)OR, N(R)N(R)CON(R)₂, N(R)SO₂R, N(R)SO₂N(R)₂, N(R)C(O)OR, N(R)C(O)R, N(R)C(S)R, N(R)C(O)N(R)₂, N(R)C(S)N(R)₂, N(COR)COR, N(OR)R, C(═NH)N(R)₂, C(O)N(OR)R, or C(═NOR)R wherein R can be hydrogen (in examples that include other carbon atoms) or a carbon-based moiety, and wherein the carbon-based moiety can itself be further substituted.

The term “substituted” as used herein refers to an organic group as defined herein or molecule in which one or more hydrogen atoms contained therein are replaced by one or more non-hydrogen atoms. The term “functional group” or “substituent” as used herein refers to a group that can be or is substituted onto a molecule or onto an organic group. Examples of substituents or functional groups include, but are not limited to, a halogen (e.g., F, Cl, Br, and I); an oxygen atom in groups such as hydroxyl groups, alkoxy groups, aryloxy groups, aralkyloxy groups, oxo(carbonyl) groups, carboxyl groups including carboxylic acids, carboxylates, and carboxylate esters; a sulfur atom in groups such as thiol groups, alkyl and aryl sulfide groups, sulfoxide groups, sulfone groups, sulfonyl groups, and sulfonamide groups; a nitrogen atom in groups such as amines, hydroxylamines, nitriles, nitro groups, N-oxides, hydrazides, azides, and enamines; and other heteroatoms in various other groups. Non-limiting examples of substituents J that can be bonded to a substituted carbon (or other) atom include F, Cl, Br, I, OR, OC(O)N(R′)₂, CN, NO, NO₂, ONO₂, azido, CF₃, OCF₃, R′, O (oxo), S (thiono), C(O), S(O), methylenedioxy, ethylenedioxy, N(R)₂, SR, SOR, SO₂R′, SO₂N(R)₂, SO₃R, C(O)R, C(O)C(O)R, C(O)CH₂C(O)R, C(S)R, C(O)OR, OC(O)R, C(O)N(R)₂, OC(O)N(R)₂, C(S)N(R)₂, (CH₂)₀₋₂N(R)C(O)R, (CH₂)₀₋₂N(R)N(R)₂, N(R)N(R)C(O)R, N(R)N(R)C(O)OR, N(R)N(R)CON(R)₂, N(R)SO₂R, N(R)SO₂N(R)₂, N(R)C(O)OR, N(R)C(O)R, N(R)C(S)R, N(R)C(O)N(R)₂, N(R)C(S)N(R)₂, N(COR)COR, N(OR)R, C(═NH)N(R)₂, C(O)N(OR)R, or C(═NOR)R wherein R can be hydrogen or a carbon-based moiety, and wherein the carbon-based moiety can itself be further substituted; for example, wherein R can be hydrogen, alkyl, acyl, cycloalkyl, aryl, aralkyl, heterocyclyl, heteroaryl, or heteroarylalkyl, wherein any alkyl, acyl, cycloalkyl, aryl, aralkyl, heterocyclyl, heteroaryl, or heteroarylalkyl or R can be independently mono- or multi-substituted with J; or wherein two R groups bonded to a nitrogen atom or to adjacent nitrogen atoms can together with the nitrogen atom or atoms form a heterocyclyl, which can be mono- or independently multi-substituted with J.

The term “alkyl” as used herein refers to straight chain and branched alkyl groups and cycloalkyl groups having from 1 to 40 carbon atoms, 1 to about 20 carbon atoms, 1 to 12 carbons or, in some embodiments, from 1 to 8 carbon atoms. Examples of straight chain alkyl groups include those with from 1 to 8 carbon atoms such as methyl, ethyl, n-propyl, n-butyl, n-pentyl, n-hexyl, n-heptyl, and n-octyl groups. Examples of branched alkyl groups include, but are not limited to, isopropyl, iso-butyl, sec-butyl, t-butyl, neopentyl, isopentyl, and 2,2-dimethylpropyl groups. As used herein, the term “alkyl” encompasses n-alkyl, isoalkyl, and anteisoalkyl groups as well as other branched chain forms of alkyl. Representative substituted alkyl groups can be substituted one or more times with any of the groups listed herein, for example, amino, hydroxy, cyano, carboxy, nitro, thio, alkoxy, and halogen groups.

The term “alkenyl” as used herein refers to straight and branched chain and cyclic alkyl groups as defined herein, except that at least one double bond exists between two carbon atoms. Thus, alkenyl groups have from 2 to 40 carbon atoms, or 2 to about 20 carbon atoms, or 2 to 12 carbons or, in some embodiments, from 2 to 8 carbon atoms. Examples include, but are not limited to vinyl, —CH═CH(CH₃), —CH═C(CH₃)₂, —C(CH₃)═CH₂, —C(CH₃)═CH(CH₃), —C(CH₂CH₃)═CH₂, cyclohexenyl, cyclopentenyl, cyclohexadienyl, butadienyl, pentadienyl, and hexadienyl among others.

The term “alkynyl” as used herein refers to straight and branched chain alkyl groups, except that at least one triple bond exists between two carbon atoms. Thus, alkynyl groups have from 2 to 40 carbon atoms, 2 to about 20 carbon atoms, or from 2 to 12 carbons or, in some embodiments, from 2 to 8 carbon atoms. Examples include, but are not limited to —C≡CH, —C≡C(CH₃), —C≡C(CH₂CH₃), —CH₂C≡CH, —CH₂C≡C(CH₃), and —CH₂C≡C(CH₂CH₃) among others.

The term “acyl” as used herein refers to a group containing a carbonyl moiety wherein the group is bonded via the carbonyl carbon atom. The carbonyl carbon atom is also bonded to another carbon atom, which can be part of an alkyl, aryl, aralkyl cycloalkyl, cycloalkylalkyl, heterocyclyl, heterocyclylalkyl, heteroaryl, heteroarylalkyl group or the like. In the special case wherein the carbonyl carbon atom is bonded to a hydrogen, the group is a “formyl” group, an acyl group as the term is defined herein. An acyl group can include 0 to about 12-20 or 12-40 additional carbon atoms bonded to the carbonyl group. An acyl group can include double or triple bonds within the meaning herein. An acryloyl group is an example of an acyl group. An acyl group can also include heteroatoms within the meaning here. A nicotinoyl group (pyridyl-3-carbonyl) is an example of an acyl group within the meaning herein. Other examples include acetyl, benzoyl, phenylacetyl, pyridylacetyl, cinnamoyl, and acryloyl groups and the like. When the group containing the carbon atom that is bonded to the carbonyl carbon atom contains a halogen, the group is termed a “haloacyl” group. An example is a trifluoroacetyl group.

The term “aryl” as used herein refers to cyclic aromatic hydrocarbons that do not contain heteroatoms in the ring. Thus aryl groups include, but are not limited to, phenyl, azulenyl, heptalenyl, biphenyl, indacenyl, fluorenyl, phenanthrenyl, triphenylenyl, pyrenyl, naphthacenyl, chrysenyl, biphenylenyl, anthracenyl, and naphthyl groups. In some embodiments, aryl groups contain about 6 to about 14 carbons in the ring portions of the groups. Aryl groups can be unsubstituted or substituted, as defined herein. Representative substituted aryl groups can be mono-substituted or substituted more than once, such as, but not limited to, 2-, 3-, 4-, 5-, or 6-substituted phenyl or 2-8 substituted naphthyl groups, which can be substituted with carbon or non-carbon groups such as those listed herein.

The term “heterocyclyl” as used herein refers to aromatic and non-aromatic ring compounds containing 3 or more ring members, of which one or more is a heteroatom such as, but not limited to, N, O, and S. Thus, a heterocyclyl can be a cycloheteroalkyl, or a heteroaryl, or if polycyclic, any combination thereof. In some embodiments, heterocyclyl groups include 3 to about 20 ring members, whereas other such groups have 3 to about 15 ring members. A heterocyclyl group designated as a C₂-heterocyclyl can be a 5-ring with two carbon atoms and three heteroatoms, a 6-ring with two carbon atoms and four heteroatoms and so forth. Likewise a C₄-heterocyclyl can be a 5-ring with one heteroatom, a 6-ring with two heteroatoms, and so forth. The number of carbon atoms plus the number of heteroatoms equals the total number of ring atoms. A heterocyclyl ring can also include one or more double bonds. A heteroaryl ring is an embodiment of a heterocyclyl group. The phrase “heterocyclyl group” includes fused ring species including those that include fused aromatic and non-aromatic groups.

The term “alkoxy” as used herein refers to an oxygen atom connected to an alkyl group, including a cycloalkyl group, as are defined herein. Examples of linear alkoxy groups include but are not limited to methoxy, ethoxy, propoxy, butoxy, pentyloxy, hexyloxy, and the like. Examples of branched alkoxy include but are not limited to isopropoxy, sec-butoxy, tert-butoxy, isopentyloxy, isohexyloxy, and the like. Examples of cyclic alkoxy include but are not limited to cyclopropyloxy, cyclobutyloxy, cyclopentyloxy, cyclohexyloxy, and the like. An alkoxy group can include one to about 12-20 or about 12-40 carbon atoms bonded to the oxygen atom, and can further include double or triple bonds, and can also include heteroatoms. For example, an allyloxy group is an alkoxy group within the meaning herein. A methoxyethoxy group is also an alkoxy group within the meaning herein, as is a methylenedioxy group in a context where two adjacent atoms of a structure are substituted therewith.

The term “amine” as used herein refers to primary, secondary, and tertiary amines having, e.g., the formula N(group)₃ wherein each group can independently be H or non-H, such as alkyl, aryl, and the like. Amines include but are not limited to R—NH₂, for example, alkylamines, arylamines, alkylarylamines; R₂NH wherein each R is independently selected, such as dialkylamines, diarylamines, aralkylamines, heterocyclylamines and the like; and R₃N wherein each R is independently selected, such as trialkylamines, dialkylarylamines, alkyldiarylamines, triarylamines, and the like. The term “amine” also includes ammonium ions as used herein.

The term “amino group” as used herein refers to a substituent of the form —NH₂, —NHR, —NR₂, —NR₃⁺, wherein each R is independently selected, and protonated forms of each, except for —NR₃⁺, which cannot be protonated. Accordingly, any compound substituted with an amino group can be viewed as an amine. An “amino group” within the meaning herein can be a primary, secondary, tertiary, or quaternary amino group. An “alkylamino” group includes a monoalkylamino, dialkylamino, and trialkylamino group.

The terms “halo,” “halogen,” or “halide” group, as used herein, by themselves or as part of another substituent, mean, unless otherwise stated, a fluorine, chlorine, bromine, or iodine atom.

The term “haloalkyl” group, as used herein, includes mono-halo alkyl groups, poly-halo alkyl groups wherein all halo atoms can be the same or different, and per-halo alkyl groups, wherein all hydrogen atoms are replaced by halogen atoms, such as fluoro. Examples of haloalkyl include trifluoromethyl, 1,1-dichloroethyl, 1,2-dichloroethyl, 1,3-dibromo-3,3-difluoropropyl, perfluorobutyl, and the like.

The term “hydrocarbon” as used herein refers to a functional group or molecule that includes carbon and hydrogen atoms. The term can also refer to a functional group or molecule that normally includes both carbon and hydrogen atoms but wherein all the hydrogen atoms are substituted with other functional groups.

As used herein, the term “hydrocarbyl” refers to a functional group derived from a straight chain, branched, or cyclic hydrocarbon, and can be alkyl, alkenyl, alkynyl, aryl, cycloalkyl, acyl, or any combination thereof.

The term “solvent” as used herein refers to a liquid that can dissolve a solid, liquid, or gas. Nonlimiting examples of solvents are silicones, organic compounds, water, alcohols, ionic liquids, and supercritical fluids.

The term “number-average molecular weight” as used herein refers to the ordinary arithmetic mean of the molecular weight of individual molecules in a sample. It is defined as the total weight of all molecules in a sample divided by the total number of molecules in the sample. Experimentally, the number-average molecular weight (Mₙ) is determined by analyzing a sample divided into molecular weight fractions of species i having nᵢ molecules of molecular weight Mᵢ through the formula Mₙ=ΣMᵢnᵢ/Σnᵢ. The number-average molecular weight can be measured by a variety of well-known methods including gel permeation chromatography, spectroscopic end group analysis, and osmometry. If unspecified, molecular weights of polymers given herein are number-average molecular weights.

The term “weight-average molecular weight” as used herein refers to M_{w}, which is equal to ΣMᵢnᵢ/ΣMᵢnᵢ, where nᵢ is the number of molecules of molecular weight Mᵢ. In various examples, the weight-average molecular weight can be determined using light scattering, small angle neutron scattering, X-ray scattering, and sedimentation velocity.

The term “room temperature” as used herein refers to a temperature of about 15° C. to 28° C.

The term “standard temperature and pressure” as used herein refers to 20° C. and 101 kPa.

As used herein, “degree of polymerization” is the number of repeating units in a polymer.

As used herein, the term “polymer” refers to a molecule having at least one repeating unit and can include copolymers.

The term “copolymer” as used herein refers to a polymer that includes at least two different monomers. A copolymer can include any suitable number of monomers.

The term “downhole” as used herein refers to under the surface of the earth, such as a location within or fluidly connected to a wellbore.

As used herein, the term “drilling fluid” refers to fluids, slurries, or muds used in drilling operations downhole, such as during the formation of the wellbore.

As used herein, the term “stimulation fluid” refers to fluids or slurries used downhole during stimulation activities of the well that can increase the production of a well, including perforation activities. In some examples, a stimulation fluid can include a fracturing fluid or an acidizing fluid.

As used herein, the term “clean-up fluid” refers to fluids or slurries used downhole during clean-up activities of the well, such as any treatment to remove material obstructing the flow of desired material from the subterranean formation. In one example, a clean-up fluid can be an acidification treatment to remove material formed by one or more perforation treatments. In another example, a clean-up fluid can be used to remove a filter cake.

As used herein, the term “fracturing fluid” refers to fluids or slurries used downhole during fracturing operations.

As used herein, the term “spotting fluid” refers to fluids or slurries used downhole during spotting operations, and can be any fluid designed for localized treatment of a downhole region. In one example, a spotting fluid can include a lost circulation material for treatment of a specific section of the wellbore, such as to seal off fractures in the wellbore and prevent sag. In another example, a spotting fluid can include a water control material. In some examples, a spotting fluid can be designed to free a stuck piece of drilling or extraction equipment, can reduce torque and drag with drilling lubricants, prevent differential sticking, promote wellbore stability, and can help to control mud weight.

As used herein, the term “completion fluid” refers to fluids or slurries used downhole during the completion phase of a well, including cementing compositions.

As used herein, the term “remedial treatment fluid” refers to fluids or slurries used downhole for remedial treatment of a well. Remedial treatments can include treatments designed to increase or maintain the production rate of a well, such as stimulation or clean-up treatments.

As used herein, the term “abandonment fluid” refers to fluids or slurries used downhole during or preceding the abandonment phase of a well.

As used herein, the term “acidizing fluid” refers to fluids or slurries used downhole during acidizing treatments. In one example, an acidizing fluid is used in a clean-up operation to remove material obstructing the flow of desired material, such as material formed during a perforation operation. In some examples, an acidizing fluid can be used for damage removal.

As used herein, the term “cementing fluid” refers to fluids or slurries used during cementing operations of a well. For example, a cementing fluid can include an aqueous mixture including at least one of cement and cement kiln dust. In another example, a cementing fluid can include a curable resinous material such as a polymer that is in an at least partially uncured state.

As used herein, the term “water control material” refers to a solid or liquid material that interacts with aqueous material downhole, such that hydrophobic material can more easily travel to the surface and such that hydrophilic material (including water) can less easily travel to the surface. A water control material can be used to treat a well to cause the proportion of water produced to decrease and to cause the proportion of hydrocarbons produced to increase, such as by selectively binding together material between water-producing subterranean formations and the wellbore while still allowing hydrocarbon-producing formations to maintain output.

As used herein, the term “packing fluid” refers to fluids or slurries that can be placed in the annular region of a well between tubing and outer casing above a packer. In various examples, the packing fluid can provide hydrostatic pressure in order to lower differential pressure across the sealing element, lower differential pressure on the wellbore and casing to prevent collapse, and protect metals and elastomers from corrosion.

As used herein, the term “fluid” refers to liquids and gels, unless otherwise indicated.

As used herein, the term “subterranean material” or “subterranean formation” refers to any material under the surface of the earth, including under the surface of the bottom of the ocean. For example, a subterranean formation or material can be any section of a wellbore and any section of a subterranean petroleum- or water-producing formation or region in fluid contact with the wellbore. Placing a material in a subterranean formation can include contacting the material with any section of a wellbore or with any subterranean region in fluid contact therewith. Subterranean materials can include any materials placed into the wellbore such as cement, drill shafts, liners, tubing, or screens; placing a material in a subterranean formation can include contacting with such subterranean materials. In some examples, a subterranean formation or material can be any below-ground region that can produce liquid or gaseous petroleum materials, water, or any section below-ground in fluid contact therewith. For example, a subterranean formation or material can be at least one of an area desired to be fractured, a fracture or an area surrounding a fracture, and a flow pathway or an area surrounding a flow pathway, wherein a fracture or a flow pathway can be optionally fluidly connected to a subterranean petroleum- or water-producing region, directly or through one or more fractures or flow pathways.

As used herein, “treatment of a subterranean formation” can include any activity directed to extraction of water or petroleum materials from a subterranean petroleum- or water-producing formation or region, for example, including drilling, stimulation, hydraulic fracturing, clean-up, acidizing, completion, cementing, remedial treatment, abandonment, and the like.

As used herein, a “flow pathway” downhole can include any suitable subterranean flow pathway through which two subterranean locations are in fluid connection. The flow pathway can be sufficient for petroleum or water to flow from one subterranean location to the wellbore or vice-versa. A flow pathway can include at least one of a hydraulic fracture, a fluid connection across a screen, across gravel pack, across proppant, including across resin-bonded proppant or proppant deposited in a fracture, and across sand. A flow pathway can include a natural subterranean passageway through which fluids can flow. In some embodiments, a flow pathway can be a water source and can include water. In some embodiments, a flow pathway can be a petroleum source and can include petroleum. In some embodiments, a flow pathway can be sufficient to divert from a wellbore, fracture, or flow pathway connected thereto at least one of water, a downhole fluid, or a produced hydrocarbon.

Method of Obtaining Data from a Subterranean Formation.

In some embodiments, the present invention provides a method of obtaining data from a subterranean formation. Various embodiments provide methods for detecting and evaluating various features and characteristics of complex fracture networks including microfractures. The method includes obtaining or providing first and second proppant particles, and in some embodiments includes obtaining or providing a composition including the first or second proppant particles (e.g., a composition including the first proppant particles, a composition including the second proppant particles, or a composition including both the first and second proppant particles). The obtaining or providing of the proppant particles or a composition including the same can occur at any suitable time and at any suitable location. The obtaining or providing of the composition can occur above the surface. For example, the obtaining or providing of the composition (or of a mixture including the composition) can occur in the subterranean formation (e.g., downhole). The method also includes placing the first and second proppants in a subterranean formation, which can optionally include placing a composition or mixture including the first or second proppant in the subterranean formation. The placing of the first or second proppant or a composition or mixture including the same in the subterranean formation can include contacting with any suitable part of the subterranean formation, or contacting with a subterranean material, such as any suitable subterranean material. The subterranean formation can be any suitable subterranean formation. In some examples, the placing of the first or second proppants, or a composition or mixture including the same, in the subterranean formation includes contacting with or placing in at least one of a fracture, at least a part of an area surrounding a fracture, a flow pathway, an area surrounding a flow pathway, and an area desired to be fractured. The placing of the first or second proppants, or a composition or mixture including the same, in the subterranean formation can be any suitable placing and can include any suitable contacting between the subterranean formation and the composition. The placing of the first or second proppants, or a composition or mixture including the same, in the subterranean formation can include at least partially depositing the first or second proppants in a fracture (e.g., fracture network), flow pathway, or area surrounding the same.

In some embodiments, the electroconductive proppant particles are formed above-surface; e.g., at least part of at least one of the first and second proppant particles are electroconductive before being placed in the subterranean formation. In some embodiments, the electroconductive proppant particles are formed in the subterranean formation; e.g., first or second proppant particles that are not electroconductive are placed in the subterranean formation and an electroconductive coating is applied to the proppant particles in the subterranean formation. In some embodiments, the electroconductive coating is applied in the subterranean formation as an emulsion including an electroconductive resin. Applying an electroconductive coating to the proppant in the subterranean formation can also include applying a coating of electroconductive material to the fracture faces or to other surfaces of the subterranean formation.

The method can include hydraulic fracturing, such as a method of hydraulic fracturing to generate a fracture or flow pathway. The placing of the first or second proppants, or a composition or mixture including the same, in the subterranean formation, or the contacting of the subterranean formation and the hydraulic fracturing, can occur at any time with respect to one another; for example, the hydraulic fracturing can occur at least one of before, during, and after the contacting or placing. In some embodiments, the contacting or placing occurs during the hydraulic fracturing, such as during any suitable stage of the hydraulic fracturing, such as during at least one of a pre-pad stage (e.g., during injection of water with no proppant, and additionally optionally mid- to low-strength acid), a pad stage (e.g., during injection of fluid only with no proppant, with some viscosifier, such as to begin to break into an area and initiate fractures to produce sufficient penetration and width to allow proppant-laden later stages to enter), or a slurry stage of the fracturing (e.g., viscous fluid with proppant). The method can include performing a stimulation treatment at least one of before, during, and after placing the first or second proppants, or a composition or mixture including the same, in the subterranean formation in the fracture, flow pathway, or area surrounding the same. The stimulation treatment can be, for example, at least one of perforating, acidizing, injecting of cleaning fluids, propellant stimulation, and hydraulic fracturing. In some embodiments, the stimulation treatment at least partially generates a fracture or flow pathway where the first or second proppants, or a composition or mixture including the same, is placed or contacted, or the placing or contacting is to an area surrounding the generated fracture or flow pathway.

The method can include transmitting at least one of an electric current and an electromagnetic field to at least part of the electroconductive proppant particles. The method can include detecting at least one of an electric current and an electromagnetic signal at least partially reflected by or conducted through the electroconductive proppant particles. The method can include using the detected reflected or conducted electric current or electromagnetic signal to determine at least one characteristic of the fracture network or a fracture therein comprising at least one of dimensions (e.g., height, width, length), fracture orientation, geometry, layout, conductivity, proppant conductivity (e.g., proppant pack conductivity), and distribution of proppant.

In various embodiments, placing the first proppant particles in the subterranean formation includes placing the first proppant particles into at least one of primary fractures and main branches of the fracture network. The primary fractures and main branches can have a smallest cross-sectional dimension large enough to fit the majority of the first proppant particles, such as greater than about 0.2 mm, or greater than about 0.2 mm or less, or greater than about 0.25 mm, 0.3, 0.35, 0.4, 0.45, 0.5, 0.55, 0.6, 0.65, 0.7, 0.75, 0.8, 0.85, 0.9, 0.95, 1, 1.25, 1.5, 1.75, 2, 2.25, 2.5, 2.75, 3, 3.25, 3.5, 3.75, 4, 4.25, 4.5, 4.75, 5, 5.5, 6, 6.5, 7, 7.5, 8, 8.5, 9, 9.5, or greater than about 10 mm or more.

In various embodiments, placing the second proppant particles in the subterranean formation includes placing the second proppant particles into microfractures (e.g., far-field fractures). The microfractures can have a smallest cross-sectional dimension that is large enough to fit the majority of the second proppant particles but too small to fit the majority of the first proppant particles, such as less than about 200 μm, or less than about 200 μm or more, or less than about 195 μm, 190, 185, 180, 175, 170, 165, 160, 155, 150, 125, 100, 95, 90, 85, 80, 75, 70, 65, 60, 55, 50, 45, 40, 35, 30, 25, 20, 15, 10, 5, 4, 3, 2, 1, 0.95, 0.9, 0.85, 0.8, 0.7, 0.6, 0.55, 0.45, 0.4, 0.35, 0.2, 0.15, 0.1, 0.08, 0.06, 0.04, or less than about 0.02 μm or less. In various embodiments, the second particles can be placed in the subterranean formation first, allowing transport and placement in the microfractures, prior to placing the second larger proppant particles in the subterranean formation.

In various embodiments, after placing at least one of the first and second proppant particles in the subterranean formation, an electroconductive proppant pack is formed that includes the electroconductive proppant particles. The transmitting the electric current or electromagnetic signal to at least part of the electroconductive proppant particles includes transmitting into at least part of the electroconductive proppant pack.

The method can include placing sensors into the subterranean formation, wherein the electroconductive proppant pack includes the sensors. For example, self-contained sensors can be placed in the proppant pack capable of collecting data about the proppant (e.g., such are characteristics of the fracture wherein the proppant is located) and providing the data to the detectors. In certain embodiments, the sensors can be placed within the propped fracture during a fracturing treatment.

### First and Second Proppant Particles.

The first and second proppant particles can include any suitable material. For example, the first and second proppant particles can independently include at least one selected from silica flour, ceramic (e.g., ceramic microspheres), glass (e.g., glass microspheres), cenospheres, shells (e.g., nut shells), seeds, fruit pit materials, ceramics, sand (e.g., natural sand, quartz sand, nut shells), gravel, garnet (e.g., particulate garnet), metal (e.g. metal particulates or beads), glass, nylon (e.g., nylon pellets), wood (e.g., processed wood), ore (e.g., bauxite, or other ores), polymeric materials (e.g., polymer beads), tetrafluoroethylene materials, and composite materials including at least one of silica, alumina, fumed silica, carbon black, graphite, mica, titanium dioxide, meta-silicate, calcium silicate, kaolin, talc, zirconia, boron, and fly ash.

The first and second proppant particles can independently have any suitable particle size, wherein the particle size is the largest dimension of the particle (e.g., diameter for a sphere). In some embodiments, the first proppant particles can have a particle size of about 0.2 mm to about 10 mm, about 0.3 mm to about 5 mm, about 0.5 mm to about 3 mm, 0.2 mm or less, 0.3, 0.4, 0.5, 0.6, 0.7, 0.8, 0.9, 1, 1.25, 1.5, 1.75, 2, 2.25, 2.5, 2.75, 3, 3.25, 3.5, 3.75, 4, 4.25, 4.5, 4.75, 5, 5.5, 6, 6.5, 7, 7.5, 8, 8.5, 9, 9.5, or about 10 mm or more. In some embodiments, the second proppant particles can have a particle size of about 0.010 μm to about 199 μm, about 0.1 μm to about 100 μm, about 1 μm to about 100 μm, or about 0.02 μm or less, 0.04, 0.06, 0.08, 0.1, 0.15, 0.2, 0.25, 0.3, 0.35, 0.4, 0.45, 0.5, 0.55, 0.6, 0.65, 0.7, 0.75, 0.8, 0.85, 0.9, 0.95, 1, 1.5, 2, 2.5, 3, 3.5, 4, 4.5, 5, 6, 8, 10, 12, 14, 16, 18, 20, 25, 30, 35, 40, 45, 50, 55, 60, 65, 70, 75, 80, 85, 90, 95, 100, 125, 150, 175, or about 200 μm or more.

Any two suitable amounts of first and second proppant particles can be placed in the subterranean formation. For example, the second proppant particles can be about 0.01 wt % to about 99.99 wt % of the total weight of the first and second proppant particles, about 0.1 wt % to about 99.9 wt %, or about 10 wt % to about 90 wt %, or about 0.01 wt % or less, or about 0.1 wt %, 0.5, 1, 2, 3, 4, 5, 6, 8, 10, 12, 14, 16, 18, 20, 25, 30, 35, 40, 45, 50, 55, 60, 65, 70, 75, 80, 85, 90, 95, 96, 97, 98, 99, 99.9, or about 99.99 wt % or more.

The method includes placing electroconductive proppant particles in the subterranean formation (e.g., downhole), or placing proppant particles in the subterranean formation and applying an electroconductive material to form electroconductive proppant particles in the subterranean formation. In various embodiments, at least one of the first proppant particles and the second proppant particles include electroconductive proppant particles. At least some of the first proppant particles can be electroconductive proppant particles. At least some of the second proppant particles can be electroconductive proppant particles. In some embodiments, at least some of the first proppant particles and at least some of the second proppant particles are electroconductive proppant particles. In some embodiments, other proppant particles placed in the subterranean formation other than the first and second proppant particles can also be electroconductive, or can be made to be electroconductive via application of electroconductive material (e.g., via application of electroconductive resin or electroconductive particles, such as in an emulsion).

The electroconductive proppant particles can include an electroconductive coating. The coating can be part of the proppant particles at the time of obtaining or providing the proppant particles before placing in the subterranean formation, or the coating can be applied after placing the particles in the subterranean formation. The electroconductive coating can include a resin and an electroconductive material. Any suitable amount of the total weight of the first proppant particles, the second proppant particles, or a combination thereof, can be electroconductive proppant particles having the electroconductive coating, such as about 20 wt % to about 100 wt %, about 30 wt % to about 90 wt %, or about 20 wt % or less, 25 wt %, 30, 35, 40, 45, 50, 55, 60, 65, 70, 75, 80, 85, 90, 95, 96, 97, 98, 99, 99.9, 99.99, or about 99.999 wt % or more of the total weight of the first proppant particles, the second proppant particles, or a combination thereof. Any suitable amount of the total surface area of an electroconductive proppant particle can include the electroconductive coating thereon, such as on about 5% to about 100% of the total surface area, or on about 5% or less, 6, 8, 10, 12, 14, 16, 18, 20, 25, 30, 35, 40, 45, 50, 55, 60, 65, 70, 75, 80, 85, 90, 95, 96, 97, 98, 99, 99.9, 99.99, or on about 99.999% or more. Any suitable amount of the total weight of an electroconductive proppant particle can be the electroconductive coating, such as about 0.001 wt % to about 50 wt %, about 0.01 wt % to about 20 wt %, about 0.1 wt % to about 6 wt %, or about 0.001 wt % or less, about 0.01 wt %, 0.1, 1, 1.5, 2, 2.5, 3, 3.5, 4, 4.5, 5, 5.5, 6, 7, 8, 9, 10, 11, 12, 13, 14, 15, 16, 17, 18, 19, 20, 22, 24, 26, 28, 30, 35, 40, 45, or about 50 wt % or more.

The electroconductive material can be any suitable material that can at least partially conduct electricity, such as at least one of a metal, an electroconductive polymer, and carbon nanomaterials (e.g., nanoparticles, nanotubes, or nanorods). In some embodiments, the electroconductive material includes at least one of graphite, silver, gold, calcium lithium, platinum, titanium, nickel, copper, iron, silver, zinc, brass, tin, aluminum, steel, and lead. In some embodiments, the electroconductive material is a powder having any suitable particle size (wherein particle size is the largest dimension of the particle), such as about 0.1 nm to about 1,000 nm, about 1 nm to about 100 nm, about 5 nm to 50 nm, or about 0.1 nm or less, or about 1 nm, 5, 10, 15, 20, 25, 30, 35, 40, 45, 50, 55, 60, 65, 70, 75, 80, 85, 90, 95, 100, 200, 300, 400, 500, 600, 700, 800, 900, or about 1,000 nm or more. In some embodiments, the powder can be a nanoconductive powder (e.g., a nanoscale powder that is electrically conductive), such as a nanoconductive metal powder. The electroconductive material can be any electroconductive material described in any one of U.S. Pat. Nos. 5,215,820, 6,416,818, 7,407,606, 7,968,009, 8,114,314, 8,481,161, and EP patent no. 2,562,766.

In some embodiments, the electroconductive material is an electroconductive polymer material, such as at least one of a polypyrrole, polyfuran, polythiophene, polyaniline, and a copolymer or derivative thereof. For example, the electroconductive polymer can include a polymer or copolymer of at least one of pyrrole, 2-acetyl-N-methylpyrrole, 3-acetyl-N methylpyrrole, Z-acetylpyrrole, 1-aminopyrrole, bilirubin, 2,5-dimethylpyrrole, N-methylpyrrole, N-methylpyrrole-Z-methyl acetate, N-methylpyrrole-2-acetonitrile, 3-nitropyrrole, 4-nitropyrrole-2-carboxylic acid, ethyl 4-nitropyrrole-Z-carboxylate, N-n-octadecylpyrrole, 1-phenylpyrrole, furan, dimethylfuran, furancarboxylic acid, ethyl furancarboxylate, isoamyl furancarboxylate, methoxyfuran, methylfuran, thiophene, acetylthiophene, bromothiophene, n-butylthiophene, chlorothiophene, n-decylthiophene, n-dodecylthiophene, ethylthiophene, n-heptylthiophene, n-hexylthiophene, iodothiphene, methylthiophene, n-nonylthiophene, n-octylthiophene, n-pentylthiophene, phenylthiophene, propionylthiophene, n-propylthiophene, terthiophene, n-undecylthiophene, aniline, bromoaniline, bromoaniline hydrochloride, chloroaniline, chloroaniline hydrochloride, dibromoaniline, dichloroaniline, diethoxyaniline, diethylaniline, difluoroaniline, fluoroaniline, diisopropylaniline, dimethoxyaniline, dinitroaniline, ethylaniline, n-heptylaniline, n-hexylaniline, iodoaniline, isopropylaniline, nitroaniline, tribromoaniline, trichloroaniline, trifluoroaniline, trimethoxyaniline, and trimethylaniline.

The resin of the electroconductive coating can be any suitable material that can bind the electroconductive material to the electroconductive proppant particle to form a coating enabling the proppant particles to be used to perform an embodiment of a method described herein. For example, the resin can be a curable or a noncurable material, and can include tackifier materials (e.g., non-curable surface-modifying material that provides adhesive or glue-like properties). In some embodiments, the resin includes at least one of a natural resin, a polyisocyanate resin, a urethane resin, a polyester resin, an epoxy resin, a novolac resin, a polyepoxide resin, bisphenol A-epichlorohydrin resin, a bisphenol A diglycidyl ether resin, a butoxymethyl butyl glycidyl ether resin, a bisphenol F resin, a glycidyl ether resin, a phenol-aldehyde resin, a phenolic-latex resin, a phenol-formaldehyde resin, a urea-aldehyde resin, a urethane resin, a polyurethane resin, a phenolic resin, a furan resin, a furan-furfuryl alcohol resin, and an acrylate resin. In some embodiments, the resin can include at least one of a shellac, a polyamide, a silyl-modified polyamide, a polyester, a polycarbonate, a polycarbamate, an acrylic acid polymer, an acrylic acid ester polymer, an acrylic acid homopolymer, an acrylic acid ester homopolymer, poly(methyl acrylate), poly(butyl acrylate), poly(2-ethylhexyl acrylate), an acrylic acid ester copolymer, a methacrylic acid derivative polymer, a methacrylic acid homopolymer, a methacrylic acid ester homopolymer, poly(methyl methacrylate), poly(butyl methacrylate), poly(2-ethylhexyl methacrylate), an acrylamidomethylpropane sulfonate polymer or copolymer or derivative thereof, an acrylic acid/acrylamidomethylpropane sulfonate copolymer, a trimer acid, a fatty acid, a fatty acid-derivative, maleic anhydride, acrylic acid, a polyester, a polycarbonate, a polycarbamate, an aldehyde, formaldehyde, a dialdehyde, glutaraldehyde, a hemiacetal, an aldehyde-releasing compound, a diacid halide, a dihalide, a dichloride, a dibromide, a polyacid anhydride, citric acid, an epoxide, furfuraldehyde, an aldehyde condensate, a silyl-modified polyamide, a condensation reaction product of a polyacid and a polyamine, and a hydrophobically-modified amine-containing polymer.

In some embodiments, the resin can include an amine-containing polymer. In some embodiments, the resin can be hydrophobically-modified. In some embodiments, the resin can include at least one of a polyamine (e.g., spermidine and spermine), a polyimine (e.g., poly(ethylene imine) and poly(propylene imine)), a polyamide, poly(2-(N,N-dimethylamino)ethyl methacrylate), poly(2-(N,N-diethylamino)ethyl methacrylate), poly(vinyl imidazole), and a copolymer comprising monomers of at least one of the foregoing and monomers of at least one non-amine-containing polymer such as of at least one of polyethylene, polypropylene, polyethylene oxide, polypropylene oxide, polyvinylpyridine, polyacrylic acid, polyacrylate, and polymethacrylate. A hydrophobic modification can be any suitable hydrophobic modification, such as at least one C₄-C₃₀ hydrocarbyl comprising at least one of a straight chain, a branched chain, an unsaturated C—C bond, an aryl group, and any combination thereof.

The resin can be any suitable amount of the electroconductive coating, such as about 0.01 wt % to about 95 wt % of the coating, about 0.1 wt % to about 90 wt %, or about 0.01 wt % or less, or about 0.1 wt %, 1, 2, 3, 4, 5, 10, 15, 20, 25, 30, 35, 40, 45, 50, 55, 60, 65, 70, 75, 80, 85, 90, or about 95 wt % or more.

In some embodiments, the first and second proppant particles include particles including a first electroconductive coating and particles including a second electroconductive coating, wherein the first electroconductive coating and the second electroconductive coating have different conductivities. In one embodiment, at least a portion of the first proppant particles are coated with a first electroconductive coating and at least a portion of the second proppant particles are coated with a second electroconductive coating, wherein the first electroconductive coating exhibits a different conductivity as compared to the second electroconductive coating. In some embodiments, the different conductivities of the first and second electroconductive coatings can help to distinguish between the electric current or electromagnetic signal reflected by or conducted through a first proppant particle in a microfracture and from a second proppant particle in a main fracture or branch thereof

In some embodiments, the method can include coating at least one fracture in the subterranean formation with an electroconductive coating. For example, the electroconductive particles and the resin can be included in a composition (e.g., an aqueous-based emulsion) and can be placed as part of the pad fluid in generating the fractures of a fracture network, such that the electroconductive coating is formed onto at least some of the faces of the fractures (e.g., microfractures, and the main fractures and their branches). In some embodiments, the method can include placing electroconductive proppant particles in the subterranean formation and coating at least one fracture in the subterranean formation. In some embodiments, the method can include placing non-electroconductive proppant particle in the subterranean formation and coating at least one fracture in the subterranean formation and also coating at least some of the proppant particles to form electroconductive proppant particles. Coating the fracture can advantageously allow for penetration of the electroconductive coating into regions of the fracture can cannot be penetrated by proppant particles. Coating the fracture can allow data to be gathered regarding the size of the fracture network and the volume of the fracture network, in addition to data regarding the placement of the proppant within the fracture network.

### Transmitter and Detector.

The method includes transmitting at least one of an electric current and an electromagnetic signal to at least part of the electroconductive proppant particles. In some embodiments, the transmitting at least one of the electric current and the electromagnetic signal includes transmitting using at least one transmitter. For example, one or more transmitters can be used to send an electrical signal into an electroconductive proppant pack. The signal can include an electric current or an electromagnetic field. Any suitable number of transmitters can be used, e.g., 1, 2, 3, 4, 5, 6, 7, 8, 9, 10, 12, 14, 16, 18, 20, 25, 30, 35, 40, 45, 50, 60, 70, 80, 90, or 100 or more. A transmitter can be located in a wellbore from which the fracture network extends, e.g., a location fluidly connected to the location of the electroconductive proppant particles in the fractures, in a well from which fracturing was performed. A transmitter can be located in a different wellbore than the wellbore from which the fracture network extends, e.g., a wellbore fluidly separated from the location of the electroconductive proppant particles in the fractures, in an offset well adjacent to the wellbore from which fracturing was performed. In some embodiments, multiple transmitters can be used, wherein some transmitters are in locations fluidly connected to the fractures including the electroconductive particles and some transmitters are in locations fluidly separated from the fractures including the electroconductive particles.

The method includes detecting at least one of an electric current and an electromagnetic signal at least partially reflected by or conducted through at least some of the electroconductive proppant particles. In some embodiments, the detecting the reflected or conducted electric current or electromagnetic signal includes detecting using at least one detector (e.g., receiver). Any suitable number of detectors can be used, e.g., 1, 2, 3, 4, 5, 6, 7, 8, 9, 10, 12, 14, 16, 18, 20, 25, 30, 35, 40, 45, 50, 60, 70, 80, 90, or 100 or more. A detector can be located in a wellbore from which the fracture network extends, e.g., a location fluidly connected to the location of the electroconductive proppant particles in the fractures, in a well from which fracturing was performed. A detector can be located in a different wellbore than the wellbore from which the fracture network extends, e.g., a wellbore fluidly separated from the location of the electroconductive proppant particles in the fractures, in an offset well adjacent to the wellbore from which fracturing was performed. In some embodiments, multiple detectors can be used, wherein some detectors are in locations fluidly connected to the fractures including the electroconductive particles and some detectors are in locations fluidly separated from the fractures including the electroconductive particles. In some embodiments, the detector can be configured to sense one or more formation parameters, such as pressure, temperature, dielectric constant, rock strain, porosity, or flow rate. In some embodiments, the detector can be used to monitor characteristics during a fracturing operation, during a clean-up operation, or during a production operation, giving data over time.

The transmitting of the electrical current can include transmitting electrical current from at least one electrode and the receiving of the electric signal can include receiving by at least one electrode. The method can include providing one or more electrodes in a position to measure the electrical resistance of the subterranean formation including the electroconductive proppant, measuring the electrical resistance of the subterranean formation, and determining the geometry or other characteristic of the fracture from the measured electrical resistance. Electrical resistivity of subsurface materials can measured by causing an electrical current to flow in the earth (including the electroconductive proppant) between one pair of electrodes while the voltage across a second pair of electrodes is measured. The result can be an “apparent” resistivity which is a value representing the weighted average resistivity over a volume of the earth. Variations in this measurement can be caused by variations in the soil, rock, and pore fluid electrical resistivity.

In various embodiments, the method can further include using the detected reflected or conducted electric current or electromagnetic signal to determine at least one characteristic of a fracture network or a fracture thereof in the subterranean formation including at least one of height, width, length, orientation, geometry, layout, conductivity, proppant conductivity, and distribution of proppant. For example, the electric or electromagnetic signal from the transmitter can be at least one of conducted along and reflected back from the electroconductive proppant to the detector and can be used to determine the dimensions and geometry of the propped fractures. For example, the strength, offset, and phase of the reflected signal can be used to determine height, width, length, and orientation of the subterranean fracture. An electric current can be used to determine the electric impedance within the electroconductive proppant. The measured impedance within the subterranean fracture can be used to quantitatively measure the proppant conductivity or the distribution of proppant conductivity through the subterranean fracture after placement of proppant.

In some embodiments, the transmitting of the electromagnetic signal can include transmitting from a radar assembly and the receiving of the electromagnetic signal can include receiving by a radar assembly. For example, the method can include providing a ground penetrating radar assembly in a position to radiate electromagnetic signals into the subterranean formation including the electroconductive proppant and to detect electromagnetic signals reflected from the electroconductive proppant in the subterranean formation. The method can include radiating electromagnetic signals into the subterranean formation, measuring the reflected electromagnetic signals, and determining at least one characteristic of the fracture from the reflected electromagnetic signals, such as height, width, length, orientation, geometry, layout, conductivity, proppant conductivity, and distribution of proppant.

### Other Components.

In various embodiments, the first proppant particles, the second proppant particles, or a combination thereof can be placed in the subterranean formation in the form of a composition that includes the first proppant particles, the second proppant particles, or a combination thereof. In some embodiments, the placing of the first or second proppant particles in the subterranean formation can include the placing of a mixture including other components in addition to a composition including the first or second proppant particles. The composition including the first or second proppant particles, or a mixture including the composition, can include any suitable additional component in any suitable proportion, such that the first and second proppant particles, the composition, or a mixture including the same can be used as described herein. In some embodiments, the method can include combining the first or second proppant particles with other components to form the composition. In some embodiments, the method can include combining the composition with other components to form the mixture. In some embodiments, the providing or obtaining of the first or second proppant particles includes providing or obtaining a composition or mixture including the first or second proppant particles, and the placing of the first or second proppant particles in the subterranean formation includes placing a composition or mixture including the first or second proppant particles in the subterranean formation.

In some embodiments, the method further includes combining at least one of the first and second proppant particles with a carrier fluid to form a mixture, wherein placing at least one of the first and second proppant particles in the subterranean formation includes placing the mixture in the subterranean formation. The carrier fluid can include at least one of water, an organic solvent, and an oil. The carrier fluid can include a fracturing fluid. The carrier fluid can include at least one of water, brine, produced water, flowback water, brackish water, and sea water. The carrier fluid can include at least one of dipropylene glycol methyl ether, dipropylene glycol dimethyl ether, dimethyl formamide, diethylene glycol methyl ether, ethylene glycol butyl ether, diethylene glycol butyl ether, propylene carbonate, D-limonene, a C₂-C₄₀ fatty acid C₁-C₁₀ alkyl ester, 2-butoxy ethanol, butyl acetate, furfuryl acetate, dimethyl sulfoxide, dimethyl formamide, diesel, kerosene, mineral oil, a hydrocarbon including an internal olefin, a hydrocarbon including an alpha olefin, xylenes, an ionic liquid, methyl ethyl ketone, and cyclohexanone. In some embodiments, the composition including the first proppant particles, the second proppant particles, or a combination thereof, can include any suitable proportion of carrier fluid, such as about 0.001 wt % to about 95 wt %, or about 0.001 wt % or less, or about 0.01 wt %, 0.1, 1, 2, 3, 4, 5, 10, 15, 20, 25, 30, 35, 40, 45, 50, 55, 60, 65, 70, 75, 80, 85, 90, or about 95 wt % or more.

In some embodiments, the composition includes a viscosifier. The viscosifier can be any suitable viscosifier. The viscosifier can affect the viscosity of the composition or a solvent that contacts the composition at any suitable time and location. In some embodiments, the viscosifier provides an increased viscosity at least one of before injection into the subterranean formation, at the time of injection downhole, during travel through a tubular disposed in a borehole, once the composition reaches a particular subterranean location, or some period of time after the composition reaches a particular subterranean location. In some embodiments, the viscosifier can be about 0.000.1 wt % to about 10 wt % of the composition, about 0.004 wt % to about 0.01 wt % of the composition, or about 0.000.1 wt % or less, 0.000.5 wt %, 0.001, 0.005, 0.01, 0.05, 0.1, 0.5, 1, 2, 3, 4, 5, 6, 7, 8, 9, or about 10 wt % or more of the composition.

The viscosifier can include at least one of a substituted or unsubstituted polysaccharide, and a substituted or unsubstituted polyalkenylene, wherein the polysaccharide or polyalkenylene is crosslinked or uncrosslinked. The viscosifier can include a polymer including at least one monomer selected from the group consisting of ethylene glycol, acrylamide, vinyl acetate, 2-acrylamidomethylpropane sulfonic acid or its salts, trimethylammoniumethyl acrylate halide, and trimethylammoniumethyl methacrylate halide. The viscosifier can include a crosslinked gel or a crosslinkable gel. The viscosifier can include at least one of a linear polysaccharide, and poly((C₂-C₁₀)alkenylene), wherein the (C₂-C₁₀)alkenylene is substituted or unsubstituted. The viscosifier can include at least one of poly(acrylic acid) or (C₁-C₅)alkyl esters thereof, poly(methacrylic acid) or (C₁-C₅)alkyl esters thereof, poly(vinyl acetate), poly(vinyl alcohol), poly(ethylene glycol), poly(vinyl pyrrolidone), polyacrylamide, poly (hydroxyethyl methacrylate), alginate, chitosan, curdlan, dextran, emulsan, a galactoglucopolysaccharide, gellan, glucuronan, N-acetyl-glucosamine, N-acetyl-heparosan, hyaluronic acid, kefiran, lentinan, levan, mauran, pullulan, scleroglucan, schizophyllan, stewartan, succinoglycan, xanthan, welan, derivatized starch, tamarind, tragacanth, guar gum, derivatized guar (e.g., hydroxypropyl guar, carboxy methyl guar, or carboxymethyl hydroxylpropyl guar), gum ghatti, gum arabic, locust bean gum, and derivatized cellulose (e.g., carboxymethyl cellulose, hydroxyethyl cellulose, carboxymethyl hydroxyethyl cellulose, hydroxypropyl cellulose, or methyl hydroxyl ethyl cellulose).

In some embodiments, the viscosifier can include at least one of a poly(vinyl alcohol) homopolymer, poly(vinyl alcohol) copolymer, a crosslinked poly(vinyl alcohol) homopolymer, and a crosslinked poly(vinyl alcohol) copolymer. The viscosifier can include a poly(vinyl alcohol) copolymer or a crosslinked poly(vinyl alcohol) copolymer including at least one of a graft, linear, branched, block, and random copolymer of vinyl alcohol and at least one of a substituted or unsubstituted (C₂-C₅₀)hydrocarbyl having at least one aliphatic unsaturated C—C bond therein, and a substituted or unsubstituted (C₂-C₅₀)alkene. The viscosifier can include a poly(vinyl alcohol) copolymer or a crosslinked poly(vinyl alcohol) copolymer including at least one of a graft, linear, branched, block, and random copolymer of vinyl alcohol and at least one of vinyl phosphonic acid, vinylidene diphosphonic acid, substituted or unsubstituted 2-acrylamido-2-methylpropanesulfonic acid, a substituted or unsubstituted (C₁-C₂₀)alkenoic acid, propenoic acid, butenoic acid, pentenoic acid, hexenoic acid, octenoic acid, nonenoic acid, decenoic acid, acrylic acid, methacrylic acid, hydroxypropyl acrylic acid, acrylamide, fumaric acid, methacrylic acid, hydroxypropyl acrylic acid, vinyl phosphonic acid, vinylidene diphosphonic acid, itaconic acid, crotonic acid, mesoconic acid, citraconic acid, styrene sulfonic acid, allyl sulfonic acid, methallyl sulfonic acid, vinyl sulfonic acid, and a substituted or unsubstituted (C₁-C₂₀)alkyl ester thereof. The viscosifier can include a poly(vinyl alcohol) copolymer or a crosslinked poly(vinyl alcohol) copolymer including at least one of a graft, linear, branched, block, and random copolymer of vinyl alcohol and at least one of vinyl acetate, vinyl propanoate, vinyl butanoate, vinyl pentanoate, vinyl hexanoate, vinyl 2-methyl butanoate, vinyl 3-ethylpentanoate, and vinyl 3-ethylhexanoate, maleic anhydride, a substituted or unsubstituted (C₁-C₂₀)alkenoic substituted or unsubstituted (C₁-C₂₀)alkanoic anhydride, a substituted or unsubstituted (C₁-C₂₀)alkenoic substituted or unsubstituted (C₁-C₂₀)alkenoic anhydride, propenoic acid anhydride, butenoic acid anhydride, pentenoic acid anhydride, hexenoic acid anhydride, octenoic acid anhydride, nonenoic acid anhydride, decenoic acid anhydride, acrylic acid anhydride, fumaric acid anhydride, methacrylic acid anhydride, hydroxypropyl acrylic acid anhydride, vinyl phosphonic acid anhydride, vinylidene diphosphonic acid anhydride, itaconic acid anhydride, crotonic acid anhydride, mesoconic acid anhydride, citraconic acid anhydride, styrene sulfonic acid anhydride, allyl sulfonic acid anhydride, methallyl sulfonic acid anhydride, vinyl sulfonic acid anhydride, and an N—(C₁-C₁₀)alkenyl nitrogen containing substituted or unsubstituted (C₁-C₁₀)heterocycle. The viscosifier can include a poly(vinyl alcohol) copolymer or a crosslinked poly(vinyl alcohol) copolymer including at least one of a graft, linear, branched, block, and random copolymer that includes a poly(vinylalcohol/acrylamide) copolymer, a poly(vinylalcohol/2-acrylamido-2-methylpropanesulfonic acid) copolymer, a poly (acrylamide/2-acrylamido-2-methylpropanesulfonic acid) copolymer, or a poly(vinylalcohol/N-vinylpyrrolidone) copolymer. The viscosifier can include a crosslinked poly(vinyl alcohol) homopolymer or copolymer including a crosslinker including at least one of chromium, aluminum, antimony, zirconium, titanium, calcium, boron, iron, silicon, copper, zinc, magnesium, and an ion thereof. The viscosifier can include a crosslinked poly(vinyl alcohol) homopolymer or copolymer including a crosslinker including at least one of an aldehyde, an aldehyde-forming compound, a carboxylic acid or an ester thereof, a sulfonic acid or an ester thereof, a phosphonic acid or an ester thereof, an acid anhydride, and an epihalohydrin.

In various embodiments, the composition can include a crosslinker. The crosslinker can be any suitable crosslinker. In some examples, the crosslinker can be incorporated in a crosslinked viscosifier, and in other examples, the crosslinker can crosslink a crosslinkable material (e.g., downhole). The crosslinker can include at least one of chromium, aluminum, antimony, zirconium, titanium, calcium, boron, iron, silicon, copper, zinc, magnesium, and an ion thereof. The crosslinker can include at least one of boric acid, borax, a borate, a (C₁-C₃₀)hydrocarbylboronic acid, a (C₁-C₃₀)hydrocarbyl ester of a (C₁-C₃₀)hydrocarbylboronic acid, a (C₁-C₃₀)hydrocarbylboronic acid-modified polyacrylamide, ferric chloride, disodium octaborate tetrahydrate, sodium metaborate, sodium diborate, sodium tetraborate, disodium tetraborate, a pentaborate, ulexite, colemanite, magnesium oxide, zirconium lactate, zirconium triethanol amine, zirconium lactate triethanolamine, zirconium carbonate, zirconium acetylacetonate, zirconium malate, zirconium citrate, zirconium diisopropylamine lactate, zirconium glycolate, zirconium triethanol amine glycolate, zirconium lactate glycolate, titanium lactate, titanium malate, titanium citrate, titanium ammonium lactate, titanium triethanolamine, titanium acetylacetonate, aluminum lactate, and aluminum citrate. The crosslinker can be about 0.000.01 wt % to about 5 wt % of the composition, about 0.001 wt % to about 0.01 wt %, or about 0.000.01 wt % or less, or about 0.000.05 wt %, 0.000,1, 0.000,5, 0.001, 0.005, 0.01, 0.05, 0.1, 0.5, 1, 2, 3, 4, or about 5 wt % or more.

In some embodiments, the composition can include a breaker. The breaker can be any suitable breaker, such that the surrounding fluid (e.g., a fracturing fluid) can be at least partially broken for more complete and more efficient recovery thereof at the conclusion of a hydraulic fracturing treatment. In some embodiments, the breaker can be encapsulated or otherwise formulated to give a delayed-release or a time-release, such that the surrounding liquid can remain viscous for a suitable amount of time prior to breaking. The breaker can be any suitable breaker; for example, the breaker can be a compound that includes a Na⁺, K⁺, Li⁺, Zn⁺, NH₄⁺, Fe²⁺, Fe³⁺, Cu¹⁺, Cu²⁺, Ca²⁺, Mg²⁺, Zn²⁺, and an Al³⁺ salt of a chloride, fluoride, bromide, phosphate, or sulfate ion. In some examples, the breaker can be an oxidative breaker or an enzymatic breaker. An oxidative breaker can be at least one of a Na⁺, K⁺, Li⁺, Zn⁺, NH₄⁺, Fe²⁺, Fe³⁺, Cu¹⁺, Cu²⁺, Ca²⁺, Mg²⁺, Zn²⁺, and an Al³⁺ salt of a persulfate, percarbonate, perborate, peroxide, perphosphosphate, permanganate, chlorite, or hyperchlorite ion. An enzymatic breaker can be at least one of an alpha or beta amylase, amyloglucosidase, oligoglucosidase, invertase, maltase, cellulase, hemi-cellulase, and mannanohydrolase. The breaker can be about 0.001 wt % to about 30 wt % of the composition, or about 0.01 wt % to about 5 wt %, or about 0.001 wt % or less, or about 0.005 wt %, 0.01, 0.05, 0.1, 0.5, 1, 2, 3, 4, 5, 6, 8, 10, 12, 14, 16, 18, 20, 22, 24, 26, 28, or about 30 wt % or more.

The composition, or a mixture including the composition, can include any suitable fluid. For example, the fluid can be at least one of dipropylene glycol methyl ether, dipropylene glycol dimethyl ether, dimethyl formamide, diethylene glycol methyl ether, ethylene glycol butyl ether, diethylene glycol butyl ether, propylene carbonate, D-limonene, a C₂-C₄₀ fatty acid C₁-C₁₀ alkyl ester, 2-butoxy ethanol, butyl acetate, furfuryl acetate, dimethyl sulfoxide, dimethyl formamide, diesel, kerosene, mineral oil, a hydrocarbon including an internal olefin, a hydrocarbon including an alpha olefin, xylenes, an ionic liquid, methyl ethyl ketone, and cyclohexanone. The fluid can form about 0.001 wt % to about 99.999 wt % of the composition or a mixture including the same, or about 0.001 wt % or less, 0.01 wt %, 0.1, 1, 2, 3, 4, 5, 6, 8, 10, 15, 20, 25, 30, 35, 40, 45, 50, 55, 60, 65, 70, 75, 80, 85, 90, 95, 96, 97, 98, 99, 99.9, 99.99, or about 99.999 wt % or more.

The composition including the first or second proppant particles can include any suitable downhole fluid. The composition including the first or second proppant particles can be combined with any suitable downhole fluid before, during, or after the placement of the composition in the subterranean formation or the contacting of the composition and the subterranean material. In some examples, the composition including the first or second proppant particles is combined with a downhole fluid above the surface, and then the combined composition is placed in a subterranean formation or contacted with a subterranean material. In another example, the composition including the first or second proppant particles is injected into a subterranean formation to combine with a downhole fluid, and the combined composition is contacted with a subterranean material or is considered to be placed in the subterranean formation. In various examples, at least one of prior to, during, and after the placement of the composition in the subterranean formation or contacting of the subterranean material and the composition, the composition is used in the subterranean formation, at least one of alone and in combination with other materials, as a fracturing fluid.

In various embodiments, the composition including the first or second proppant particles or a mixture including the same can include any suitable downhole fluid, such as a fracturing fluid. The placement of the composition in the subterranean formation can include contacting the subterranean material and the mixture. Any suitable weight percent of the composition or of a mixture including the same that is placed in the subterranean formation or contacted with the subterranean material can be the downhole fluid, such as about 0.000,000.01 wt % to about 99.999.99 wt %, about 0.000.1 wt % to about 99.9 wt %, about 0.1 wt % to about 99.9 wt %, about 20 wt % to about 90 wt %, or about 0.000,000.01 wt % or less, or about 0.000,001 wt %, 0.000,1, 0.001, 0.01, 0.1, 1, 2, 3, 4, 5, 10, 15, 20, 30, 40, 50, 60, 70, 80, 85, 90, 91, 92, 93, 94, 95, 96, 97, 98, 99, 99.9, 99.99, 99.999, 99.999.9 wt %, or about 99.999.99 wt % or more of the composition or mixture including the same.

In some embodiments, the composition or a mixture including the same can include any suitable amount of any suitable material used in a downhole fluid. For example, the composition can include water, saline, aqueous base, acid, oil, organic solvent, synthetic fluid oil phase, aqueous solution, alcohol or polyol, cellulose, starch, alkalinity control agents, acidity control agents, density control agents, density modifiers, emulsifiers, dispersants, polymeric stabilizers, crosslinking agents, polyacrylamide, a polymer or combination of polymers, antioxidants, heat stabilizers, foam control agents, solvents, diluents, plasticizer, filler or inorganic particle, pigment, dye, precipitating agent, rheology modifier, oil-wetting agents, set retarding additives, surfactants, gases, weight reducing additives, heavy-weight additives, lost circulation materials, filtration control additives, salts, fibers, thixotropic additives, breakers, crosslinkers, rheology modifiers, curing accelerators, curing retarders, pH modifiers, chelating agents, scale inhibitors, enzymes, resins, water control materials, oxidizers, markers, Portland cement, pozzolana cement, gypsum cement, high alumina content cement, slag cement, silica cement, fly ash, metakaolin, shale, zeolite, a crystalline silica compound, amorphous silica, hydratable clays, microspheres, pozzolan lime, or a combination thereof. In various embodiments, the composition can include one or more additive components such as: thinner additives such as COLDTROL®, ATC®, OMC 2™, and OMC 42™; RHEMOD™, a viscosifier and suspension agent including a modified fatty acid; additives for providing temporary increased viscosity, such as for shipping (e.g., transport to the well site) and for use in sweeps (for example, additives having the trade name TEMPERUS™ (a modified fatty acid) and VIS-PLUS®, a thixotropic viscosifying polymer blend); TAU-MOD™, a viscosifying/suspension agent including an amorphous/fibrous material; additives for filtration control, for example, ADAPTA®, a high temperature high pressure (HTHP) filtration control agent including a crosslinked copolymer; DURATONE® HT, a filtration control agent that includes an organophilic lignite, more particularly organophilic leonardite; THERMO TONE™, a HTHP filtration control agent including a synthetic polymer; BDF™-366, a HTHP filtration control agent; BDF™-454, a HTHP filtration control agent; LIQUITONE™, a polymeric filtration agent and viscosifier; additives for HTHP emulsion stability, for example, FACTANT™, which includes highly concentrated tall oil derivative; emulsifiers such as LE SUPERMUL™ and EZ MUL® NT, polyaminated fatty acid emulsifiers, and FORTI-MUL®; DRIL TREAT®, an oil wetting agent for heavy fluids; BARACARB®, a sized ground marble bridging agent; BAROID®, a ground barium sulfate weighting agent; BAROLIFT®, a hole sweeping agent; SWEEP-WATE®, a sweep weighting agent; BDF-508, a diamine dimer rheology modifier; GELTONE® II organophilic clay; BAROFIBRE™ O for lost circulation management and seepage loss prevention, including a natural cellulose fiber; STEELSEAL®, a resilient graphitic carbon lost circulation material; HYDRO-PLUG®, a hydratable swelling lost circulation material; lime, which can provide alkalinity and can activate certain emulsifiers; and calcium chloride, which can provide salinity. Any suitable proportion of the composition or mixture including the composition can include any optional component listed in this paragraph, such as about 0.000,000.01 wt % to about 99.999.99 wt %, about 0.000,1 to about 99.9 wt %, about 0.1 wt % to about 99.9 wt %, about 20 to about 90 wt %, or about 0.000,000.01 wt % or less, or about 0.000,001 wt %, 0.000,1, 0.001, 0.01, 0.1, 1, 2, 3, 4, 5, 10, 15, 20, 30, 40, 50, 60, 70, 80, 85, 90, 91, 92, 93, 94, 95, 96, 97, 98, 99, 99.9, 99.99, 99.999, 99.999.9 wt %, or about 99.999.99 wt % or more of the composition or mixture.

### System or Apparatus.

In various embodiments, the present invention provides a system or apparatus for obtaining data from a subterranean formation. The system or apparatus can be any suitable system or apparatus that can be used to perform or that can be generated by an embodiment of a method described herein.

In one embodiment, the system includes first proppant particles and second proppant particles, wherein the first proppant particles have a particle size of about 0.2 mm to about 10 mm, the second proppant particles have a particle size of about 0.010 μm to about 199 μm, and at least part of at least one of the first and second proppant particles include electroconductive proppant particles. The system can include a subterranean formation including the first and second proppant particles therein. The system can include a transmitter configured to transmit at least one of an electric current and an electromagnetic field into at least part of the electroconductive proppant particles. The system can include a detector configured to detect at least one of an electric current and an electromagnetic signal at least partially reflected by or conducted through at least some of the electroconductive proppant particles.

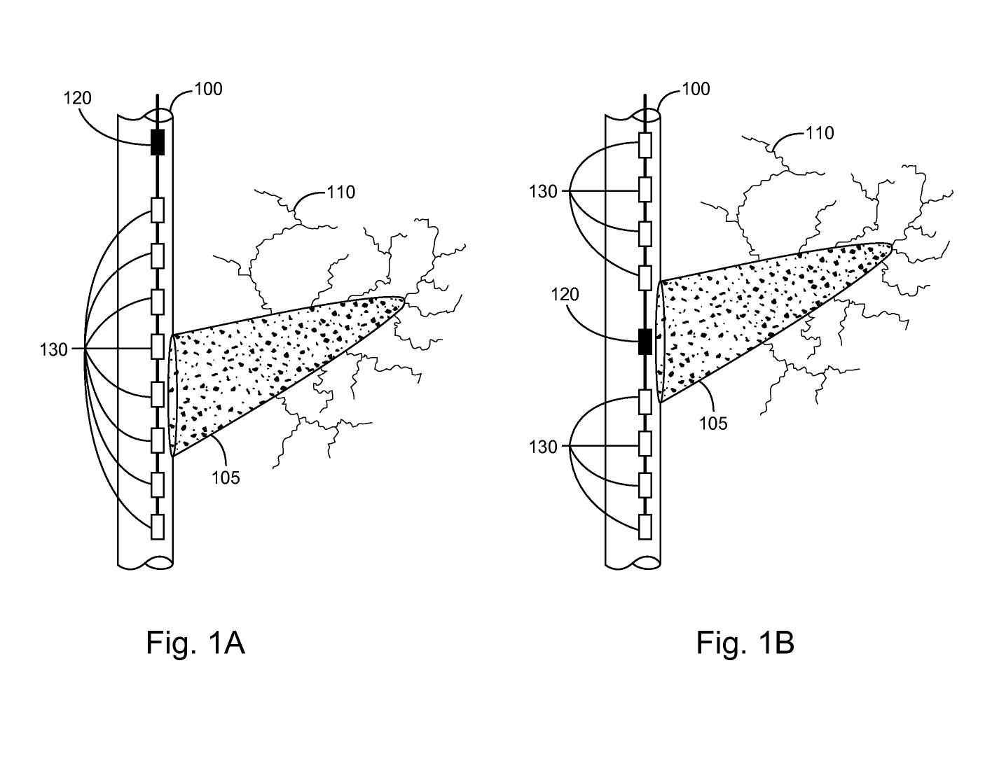

FIGS. 1a-b illustrate embodiments of a system for performing the method, wherein the fracture network including the electroconductive proppant extends from wellbore 100. The fracture network includes main fracture 105 and microfractures 110. A single transmitter 120 and multiple detectors 130 are shown, wherein the transmitter 120 and the detectors 130 are in the wellbore 100, the well wherein the fracturing treatment was conducted that formed the fracture network, e.g., in locations fluidly connected to the fracture network.

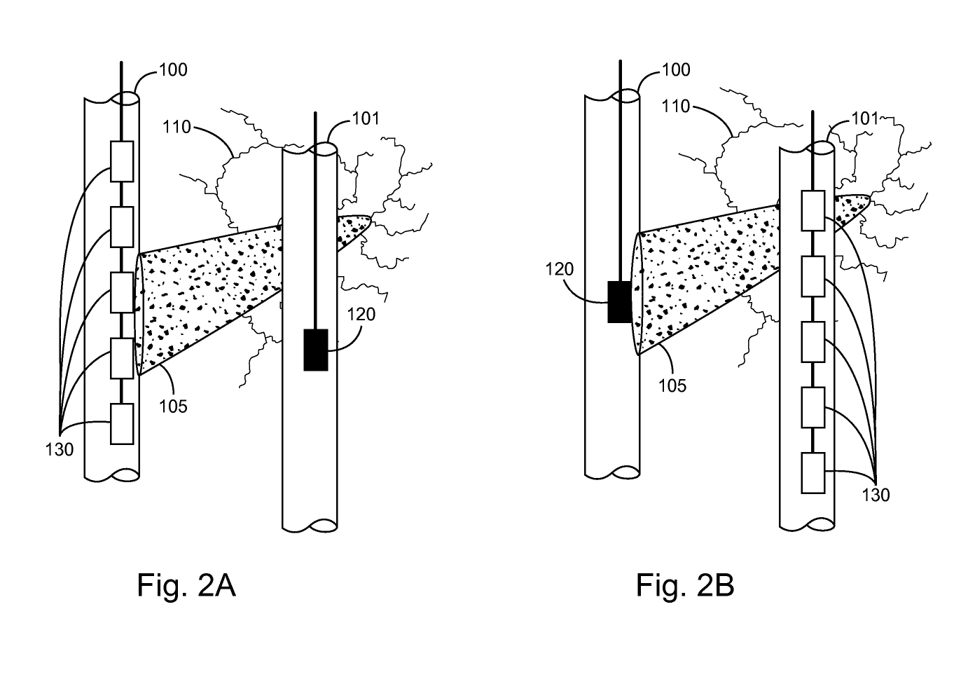

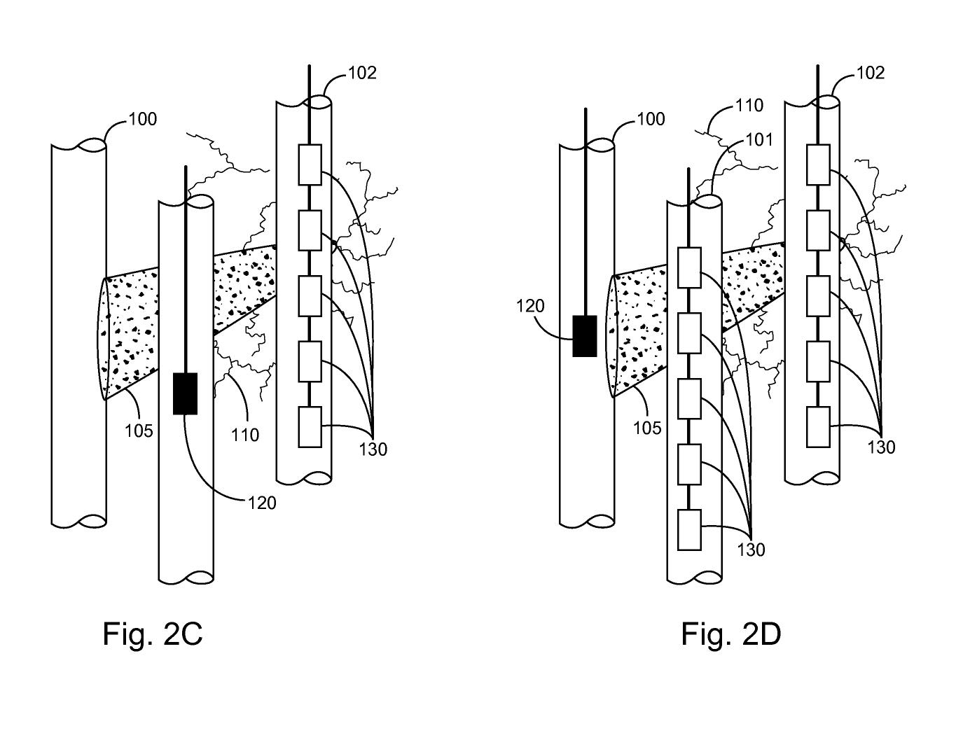

FIGS. 2a-d illustrate embodiments of a system for performing the method wherein the fracture network including the electroconductive proppant extends from wellbore 100. The fracture network includes main fracture 105 and microfractures 110 extending therefrom. In FIG. 2a, the multiple detectors 130 are in the original wellbore 100, in locations fluidly connected to the location of the electroconductive proppant. The transmitter 120 is located in an offset wellbore 101, in a location fluidly separated from the location of the electroconductive proppant. In FIG. 2b, the multiple detectors 130 are located in an offset wellbore 101, in a location fluidly separated from the location of the electroconductive proppant. The transmitter 120 is in the original wellbore 100, in a location fluidly connected to the location of the electroconductive proppant. In FIG. 2c, the transmitter 120 is in an offset wellbore 101, in a location fluidly separated from the location of the electroconductive proppant. The multiple detectors 130 are located in a second offset wellbore 102, in a location fluidly separated from the location of the electroconductive proppant. In FIG. 2d, the multiple detectors 130 are located in two offset wellbores 101 and 102, in locations fluidly separated from the location of the electroconductive proppant. The transmitter 120 is in the original wellbore 100, in a location fluidly connected to the location of the electroconductive proppant.

Various embodiments provide systems and apparatus configured for delivering a composition or mixture including the first and second proppants described herein to a location in a subterranean formation and for using the composition or mixture therein, such as to collect data from the subterranean formation. In various embodiments, the systems can include a pump fluidly coupled to a tubular (e.g., any suitable type of oilfield pipe, such as pipeline, drill pipe, production tubing, and the like), the tubular containing a composition or mixture including the first or second proppants described herein.

The pump can be a high pressure pump in some embodiments. As used herein, the term “high pressure pump” will refer to a pump that is capable of delivering a fluid to a subterranean formation at a pressure of about 1000 psi or greater. A high pressure pump can be used when it is desired to introduce the composition or mixture to a subterranean formation at or above a fracture gradient of the subterranean formation, but it can also be used in cases where fracturing is not desired. In some embodiments, the high pressure pump can be capable of fluidly conveying particulate matter, such as proppant particulates, into the subterranean formation. Suitable high pressure pumps will be known to one having ordinary skill in the art and can include, but are not limited to, floating piston pumps and positive displacement pumps.

In other embodiments, the pump can be a low pressure pump. As used herein, the term “low pressure pump” will refer to a pump that operates at a pressure of about 1000 psi or less. In some embodiments, a low pressure pump can be fluidly coupled to a high pressure pump that is fluidly coupled to the tubular. That is, in such embodiments, the low pressure pump can be configured to convey the composition or mixture to the high pressure pump. In such embodiments, the low pressure pump can “step up” the pressure of the composition or mixture before it reaches the high pressure pump.

In some embodiments, the systems or apparatuses described herein can further include a mixing tank that is upstream of the pump and in which the composition or mixture is formulated. In various embodiments, the pump (e.g., a low pressure pump, a high pressure pump, or a combination thereof) can convey the composition or mixture from the mixing tank or other source of the composition or mixture to the tubular. In other embodiments, however, the composition or mixture can be formulated offsite and transported to a worksite, in which case the composition or mixture can be introduced to the tubular via the pump directly from its shipping container (e.g., a truck, a railcar, a barge, or the like) or from a transport pipeline. In either case, the composition or mixture can be drawn into the pump, elevated to an appropriate pressure, and then introduced into the tubular for delivery to a subterranean formation.

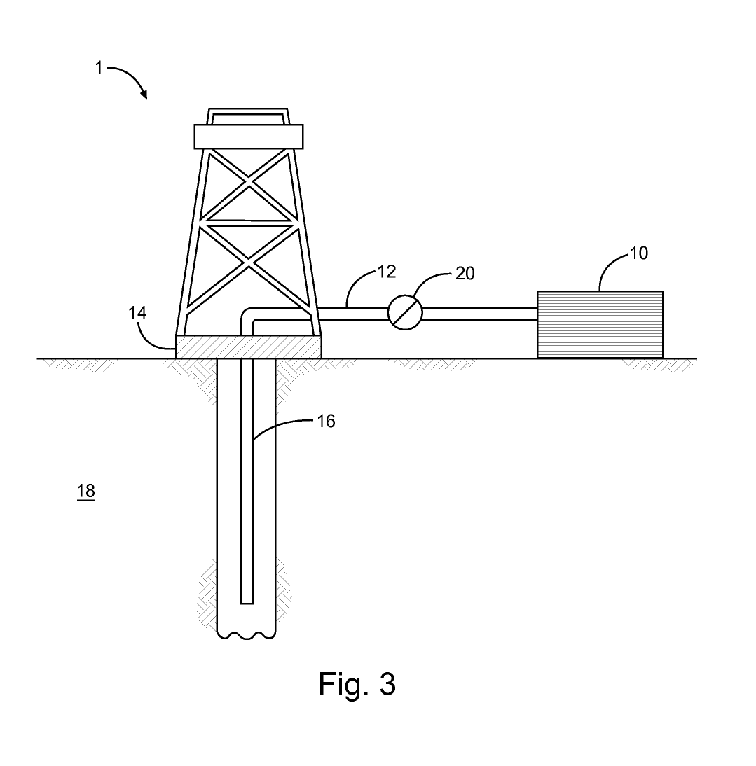

FIG. 3 shows an illustrative schematic of systems and apparatuses that can deliver embodiments of the composition or mixture including the first and second proppants to a location in a subterranean formation (e.g., downhole), according to one or more embodiments. It should be noted that while FIG. 3 generally depicts a land-based system or apparatus, it is to be recognized that like systems and apparatuses can be operated in subsea locations as well. Embodiments of the present invention can have a different scale than that depicted in FIG. 3. As depicted in FIG. 3, system or apparatus 1 can include mixing tank 10, in which an embodiment of the composition or mixture can be formulated. The composition or mixture can be conveyed via line 12 to wellhead 14, where the composition or mixture enters tubular 16, with tubular 16 extending from wellhead 14 into subterranean formation 18. Upon being ejected from tubular 16, the composition or mixture can subsequently penetrate into subterranean formation 18. Pump 20 can be configured to raise the pressure of the composition or mixture to a desired degree before its introduction into tubular 16. It is to be recognized that system or apparatus 1 is merely exemplary in nature and various additional components can be present that have not necessarily been depicted in FIG. 3 in the interest of clarity. Non-limiting additional components that can be present include, but are not limited to, supply hoppers, valves, condensers, adapters, joints, gauges, sensors, compressors, pressure controllers, pressure sensors, flow rate controllers, flow rate sensors, temperature sensors, and the like.

It is also to be recognized that a composition or mixture including the first and second proppants can also directly or indirectly affect the various downhole equipment and tools that can come into contact with the composition or mixture during operation. Such equipment and tools can include, but are not limited to, wellbore casing, wellbore liner, completion string, insert strings, drill string, coiled tubing, slickline, wireline, drill pipe, drill collars, mud motors, downhole motors and/or pumps, surface-mounted motors and/or pumps, centralizers, turbolizers, scratchers, floats (e.g., shoes, collars, valves, and the like), logging tools and related telemetry equipment, actuators (e.g., electromechanical devices, hydromechanical devices, and the like), sliding sleeves, production sleeves, plugs, screens, filters, flow control devices (e.g., inflow control devices, autonomous inflow control devices, outflow control devices, and the like), couplings (e.g., electro-hydraulic wet connect, dry connect, inductive coupler, and the like), control lines (e.g., electrical, fiber optic, hydraulic, and the like), surveillance lines, drill bits and reamers, sensors or distributed sensors, downhole heat exchangers, valves and corresponding actuation devices, tool seals, packers, cement plugs, bridge plugs, and other wellbore isolation devices or components, and the like. Any of these components can be included in the systems and apparatuses generally described above and depicted in FIG. 3.

The terms and expressions that have been employed are used as terms of description and not of limitation, and there is no intention in the use of such terms and expressions of excluding any equivalents of the features shown and described or portions thereof, but it is recognized that various modifications are possible within the scope of the embodiments of the present invention. Thus, it should be understood that although the present invention has been specifically disclosed by specific embodiments and optional features, modification and variation of the concepts herein disclosed may be resorted to by those of ordinary skill in the art, and that such modifications and variations are considered to be within the scope of embodiments of the present invention.

### Additional Embodiments

The following exemplary embodiments are provided, the numbering of which is not to be construed as designating levels of importance:

Embodiment 1 provides a method of obtaining data from a subterranean formation, the method comprising:
obtaining or providing first proppant particles and second proppant particles, wherein
   the first proppant particles have a particle size of about 0.2 mm to about 10 mm, and
   the second proppant particles have a particle size of about 0.010 μm to about 199 μm;
placing the first and second proppant particles into a subterranean formation, wherein in the subterranean formation at least part of at least one of the first and second proppant particles comprise electroconductive proppant particles;
transmitting at least one of an electric current and an electromagnetic signal to at least part of the electroconductive proppant particles; and
detecting at least one of an electric current and an electromagnetic signal at least partially reflected by or conducted through at least some of the electroconductive proppant particles.

Embodiment 2 provides the method of Embodiment 1, wherein placing the first and second proppant particles in the subterranean formation comprises placing the first and second proppant particles in a subterranean fracture network.

Embodiment 3 provides the method of any one of Embodiments 1-2, wherein placing the first proppant particles in the subterranean formation comprises placing the first proppant particles into at least one of primary fractures and main branches of a fracture network.

Embodiment 4 provides the method of Embodiment 3, wherein the primary fractures and main branches have a smallest cross-sectional dimension of greater than about 0.2 mm.

Embodiment 5 provides the method of any one of Embodiments 1-4, wherein placing the second proppant particles in the subterranean formation comprises placing the second proppant particles into microfractures.

Embodiment 6 provides the method of Embodiment 5, wherein the microfractures have a smallest cross-sectional dimension of less than about 200 μm.

Embodiment 7 provides the method of any one of Embodiments 1-6, wherein the method further comprises combining at least one of the first and second proppant particles with a carrier fluid to form a mixture, wherein placing at least one of the first and second proppant particles in the subterranean formation comprises placing the mixture in the subterranean formation.

Embodiment 8 provides the method of Embodiment 7, wherein the carrier fluid comprises at least one of water, an organic solvent, and an oil.

Embodiment 9 provides the method of any one of Embodiments 7-8, wherein the carrier fluid comprises a fracturing fluid.

Embodiment 10 provides the method of any one of Embodiments 7-9, wherein the carrier fluid comprises at least one of water, brine, produced water, flowback water, brackish water, and sea water.

Embodiment 11 provides the method of any one of Embodiments 7-10, wherein the carrier fluid comprises at least one of dipropylene glycol methyl ether, dipropylene glycol dimethyl ether, dimethyl formamide, diethylene glycol methyl ether, ethylene glycol butyl ether, diethylene glycol butyl ether, propylene carbonate, D-limonene, a C₂-C₄₀ fatty acid C₁-C₁₀ alkyl ester, 2-butoxy ethanol, butyl acetate, furfuryl acetate, dimethyl sulfoxide, dimethyl formamide, diesel, kerosene, mineral oil, a hydrocarbon comprising an internal olefin, a hydrocarbon comprising an alpha olefin, xylenes, an ionic liquid, methyl ethyl ketone, and cyclohexanone.

Embodiment 12 provides the method of any one of Embodiments 7-11, wherein about 0.001 wt % to about 95 wt % of the mixture comprising at least one of the first and second proppant particles is the carrier fluid.

Embodiment 13 provides the method of any one of Embodiments 1-12, wherein placing at least one of the first and second proppant particles in the subterranean formation comprises forming an electroconductive proppant pack that comprises the electroconductive proppant particles.

Embodiment 14 provides the method of Embodiment 13, wherein the transmitting the electric current or electromagnetic signal to at least part of the electroconductive proppant particles comprises transmitting into at least part of the electroconductive proppant pack.

Embodiment 15 provides the method of any one of Embodiments 13-14, further comprising placing sensors into the subterranean formation, wherein the electroconductive proppant pack comprises the sensors.

Embodiment 16 provides the method of any one of Embodiments 1-15, further comprising fracturing the subterranean formation.

Embodiment 17 provides the method of any one of Embodiments 1-16, wherein the placing of at least one of the first and second proppant particles in the subterranean formation comprises fracturing at least part of the subterranean formation to form at least one subterranean fracture.

Embodiment 18 provides the method of any one of Embodiments 1-17, wherein the first and second proppant particles independently comprise at least one selected from silica flour, ceramic, glass, cenospheres, shells, seeds, fruit pit materials, sand, ceramics, sand, gravel, garnet, metal, glass, nylon, wood, ore, bauxite, polymeric materials, tetrafluoroethylene materials, and composite materials comprising at least one of silica, alumina, fumed silica, carbon black, graphite, mica, titanium dioxide, meta-silicate, calcium silicate, kaolin, talc, zirconia, boron, and fly ash.

Embodiment 19 provides the method of any one of Embodiments 1-18, wherein the first proppant particles have a particle size of about 0.5 mm to about 3 mm.

Embodiment 20 provides the method of any one of Embodiments 1-19, wherein the second proppant particles have a particle size of about 0.1 μm to about 100 μm.

Embodiment 21 provides the method of any one of Embodiments 1-20, wherein the second proppant particles are about 0.01 wt % to about 99.99 wt % of the total weight of the first and second proppant particles.

Embodiment 22 provides the method of any one of Embodiments 1-21, wherein the electroconductive proppant particles comprise at least some of the first proppant particles.

Embodiment 23 provides the method of any one of Embodiments 1-22, wherein the electroconductive proppant particles are formed in the subterranean formation from at least one of the first and second proppant particles.

Embodiment 24 provides the method of any one of Embodiments 1-23, wherein the electroconductive proppant particles are electroconductive proppant particles prior to placement in the subterranean formation.

Embodiment 25 provides the method of any one of Embodiments 1-24, wherein the electroconductive proppant particles comprises at least some of the second proppant particles.

Embodiment 26 provides the method of any one of Embodiments 1-25, wherein the electroconductive particles comprise at least some of the first proppant particles and at least some of the second proppant particles.

Embodiment 27 provides the method of any one of Embodiments 1-26, wherein the electroconductive proppant particles comprise an electroconductive coating comprising a resin and an electroconductive material.

Embodiment 28 provides the method of Embodiment 27, wherein the electroconductive coating is placed on the electroconductive proppant particles in the subterranean formation.

Embodiment 29 provides the method of any one of Embodiments 27-28, wherein about 20 wt % to about 100 wt % of the total weight of the first proppant particles and the second proppant particles comprise the electroconductive coating.

Embodiment 30 provides the method of any one of Embodiments 27-29, wherein about 30 wt % to about 90 wt % of the total weight of the first proppant particles and the second proppant particles comprise the electroconductive coating.

Embodiment 31 provides the method of any one of Embodiments 27-30, wherein the electroconductive coating is on about 5% to about 100% of a total surface area of the electroconductive proppant particles.

Embodiment 32 provides the method of any one of Embodiments 27-31, wherein the electroconductive coating is about 0.1 wt % to about 6 wt % of a total weight of the coated electroconductive proppant particles.

Embodiment 33 provides the method of any one of Embodiments 27-32, wherein the resin comprises at least one of a natural resin, a polyisocyanate resin, a urethane resin, a polyester resin, an epoxy resin, a novolac resin, a polyepoxide resin, bisphenol A-epichlorohydrin resin, a bisphenol A diglycidyl ether resin, a butoxymethyl butyl glycidyl ether resin, a bisphenol F resin, a glycidyl ether resin, a phenol-aldehyde resin, a phenolic-latex resin, a phenol-formaldehyde resin, a urea-aldehyde resin, a urethane resin, a polyurethane resin, a phenolic resin, a furan resin, a furan-furfuryl alcohol resin, and an acrylate resin.

Embodiment 34 provides the method of any one of Embodiments 27-33, wherein the resin comprises at least one of a shellac, a polyamide, a silyl-modified polyamide, a polyester, a polycarbonate, a polycarbamate, an acrylic acid polymer, an acrylic acid ester polymer, an acrylic acid homopolymer, an acrylic acid ester homopolymer, poly(methyl acrylate), poly(butyl acrylate), poly(2-ethylhexyl acrylate), an acrylic acid ester copolymer, a methacrylic acid derivative polymer, a methacrylic acid homopolymer, a methacrylic acid ester homopolymer, poly(methyl methacrylate), poly(butyl methacrylate), poly(2-ethylhexyl methacrylate), an acrylamidomethylpropane sulfonate polymer or copolymer or derivative thereof, an acrylic acid/acrylamidomethylpropane sulfonate copolymer, a trimer acid, a fatty acid, a fatty acid-derivative, maleic anhydride, acrylic acid, a polyester, a polycarbonate, a polycarbamate, an aldehyde, formaldehyde, a dialdehyde, glutaraldehyde, a hemiacetal, an aldehyde-releasing compound, a diacid halide, a dihalide, a dichloride, a dibromide, a polyacid anhydride, citric acid, an epoxide, furfuraldehyde, an aldehyde condensate, a silyl-modified polyamide, a condensation reaction product of a polyacid and a polyamine, and a hydrophobically-modified amine-containing polymer.

Embodiment 35 provides the method of any one of Embodiments 27-34, wherein the resin is about 0.01 wt % to about 95 wt % of the electroconductive coating.

Embodiment 36 provides the method of any one of Embodiments 27-35, wherein the electroconductive material comprises at least one of a metal, an electroconductive polymer, and carbon nanomaterials.

Embodiment 37 provides the method of any one of Embodiments 27-36, wherein the electroconductive material comprises at least one of graphite, silver, gold, calcium lithium, platinum, titanium, nickel, copper, iron, silver, zinc, brass, tin, aluminum, steel, and lead.

Embodiment 38 provides the method of any one of Embodiments 27-37, wherein the electroconductive material comprises a powder.

Embodiment 39 provides the method of Embodiment 38, wherein the powder has a particle size of about 1 nm to about 100 nm.

Embodiment 40 provides the method of any one of Embodiments 36-39, wherein the electroconductive polymer comprises at least one of a polypyrrole, polyfuran, polythiophene, polyaniline, and a derivative thereof.

Embodiment 41 provides the method of any one of Embodiments 36-40, wherein the electroconductive polymer comprises a polymer or copolymer of at least one of pyrrole, 2-acetyl-N-methylpyrrole, 3-acetyl-N methylpyrrole, Z-acetylpyrrole, 1-aminopyrrole, bilirubin, 2,5-dimethylpyrrole, N-methylpyrrole, N-methylpyrrole-Z-methyl acetate, N-methylpyrrole-2-acetonitrile, 3-nitropyrrole, 4-nitropyrrole-2-carboxylic acid, ethyl 4-nitropyrrole-Z-carboxylate, N-n-octadecylpyrrole, 1-phenylpyrrole, furan, dimethylfuran, furancarboxylic acid, ethyl furancarboxylate, isoamyl furancarboxylate, methoxyfuran, methylfuran, thiophene, acetylthiophene, bromothiophene, n-butylthiophene, chlorothiophene, n-decylthiophene, n-dodecylthiophene, ethylthiophene, n-heptylthiophene, n-hexylthiophene, iodothiphene, methylthiophene, n-nonylthiophene, n-octylthiophene, n-pentylthiophene, phenylthiophene, propionylthiophene, n-propylthiophene, terthiophene, n-undecylthiophene, aniline, bromoaniline, bromoaniline hydrochloride, chloroaniline, chloroaniline hydrochloride, dibromoaniline, dichloroaniline, diethoxyaniline, diethylaniline, difluoroaniline, fluoroaniline, diisopropylaniline, dimethoxyaniline, dinitroaniline, ethylaniline, n-heptylaniline, n-hexylaniline, iodoaniline, isopropylaniline, nitroaniline, tribromoaniline, trichloroaniline, trifluoroaniline, trimethoxyaniline, and trimethylaniline.

Embodiment 42 provides the method of any one of Embodiments 36-41, wherein the electroconductive polymer comprises particles having a particle size of about 1 nm to about 100 nm.

Embodiment 43 provides the method of any one of Embodiments 1-42, wherein the first and second proppant particles comprise particles comprising a first electroconductive coating and particles comprising a second electroconductive coating, wherein the first electroconductive coating and the second electroconductive coating have different conductivities.

Embodiment 44 provides the method of any one of Embodiments 1-43, wherein the method further comprises coating at least one fracture in the subterranean formation with an electroconductive coating.

Embodiment 45 provides the method of any one of Embodiments 1-44, wherein the transmitting at least one of the electric current and the electromagnetic signal comprises transmitting using at least one transmitter.

Embodiment 46 provides the method of Embodiment 45, wherein the transmitter is in a location fluidly connected to a location of the electroconductive proppant particles.

Embodiment 47 provides the method of any one of Embodiments 45-46, wherein the transmitter is in a location fluidly separated from a location of the electroconductive proppant particles.

Embodiment 48 provides the method of any one of Embodiments 1-47, wherein the detecting the reflected or conducted electric current or electromagnetic signal comprises detecting using at least one detector.

Embodiment 49 provides the method of Embodiment 48, wherein the detector is in a location fluidly connected to a location of the electroconductive proppant particles.

Embodiment 50 provides the method of any one of Embodiments 48-49, wherein the detector is in a location fluidly separated from a location of the electroconductive proppant particles.

Embodiment 51 provides the method of any one of Embodiments 1-50, further comprising using the detected reflected or conducted electric current or electromagnetic signal to determine at least one characteristic of a fracture network or a fracture thereof in the subterranean formation comprising at least one of height, width, length, orientation, geometry, layout, conductivity, proppant conductivity, and distribution of proppant.

Embodiment 52 provides the method of any one of Embodiments 1-51, wherein the transmitting of the electrical current comprises transmitting the electrical current from at least one electrode and the receiving of the electric signal comprises receiving by at least one electrode.

Embodiment 53 provides the method of any one of Embodiments 1-52, wherein the transmitting of the electromagnetic signal comprises transmitting from a radar assembly and the receiving of the electromagnetic signal comprises receiving by a radar assembly.

Embodiment 54 provides a system for performing the method of any one of Embodiments 1-53, the system comprising:
a subterranean formation comprising the first and second proppant particles therein;
a transmitter configured to transmit the electric current or the electromagnetic field into the electroconductive proppant particles; and
a detector configured to detect the electric current or the electromagnetic signal at least partially reflected by or conducted through at least some of the electroconductive proppant particles.

Embodiment 55 provides a method of obtaining data from a subterranean formation, the method comprising:
obtaining or providing first proppant particles and second proppant particles, wherein
   the first proppant particles have a particle size of about 0.2 mm to about 10 mm, and
   the second proppant particles have a particle size of about 0.010 μm to about 199 μm;
placing the first and second proppant particles into a fracture network in a subterranean formation, wherein the first proppant particles are placed in the fracture network in primary fractures or in main fracture branches having a smallest cross-sectional dimension of greater than about 0.2 mm and the second proppant particles are placed in the fracture network in microfractures having a smallest cross-sectional dimension of less than about 200 μm, wherein at least the second proppant particles in the subterranean formation comprise electroconductive proppant particles comprising an electroconductive coating comprising a resin and an electroconductive material;
transmitting at least one of an electric current and an electromagnetic field to at least part of the electroconductive proppant particles; and
detecting at least one of an electric current and an electromagnetic signal at least partially reflected by or conducted through the electroconductive proppant particles, and using the detected reflected or conducted electric current or electromagnetic signal to determine at least one characteristic of the fracture network or a fracture therein comprising at least one of height, width, length, fracture orientation, geometry, layout, conductivity, proppant conductivity, and distribution of proppant.

Embodiment 56 provides a system for obtaining data from a subterranean formation, the system comprising:
first proppant particles and second proppant particles, wherein
   the first proppant particles have a particle size of about 0.2 mm to about 10 mm,
   the second proppant particles have a particle size of about 0.010 μm to about 199 μm, and
   at least part of at least one of the first and second proppant particles comprise electroconductive proppant particles;
a subterranean formation comprising the first and second proppant particles therein;
a transmitter configured to transmit at least one of an electric current and an electromagnetic field into at least part of the electroconductive proppant particles; and
a detector configured to detect at least one of an electric current and an electromagnetic signal at least partially reflected by or conducted through at least some of the electroconductive proppant particles.

Embodiment 57 provides the composition, apparatus, method, or system of any one or any combination of Embodiments 1-56 optionally configured such that all elements or options recited are available to use or select from.

1-56. (canceled)

57. A method of obtaining data from a subterranean formation, the method comprising:
placing first and second proppant particles into a subterranean formation, wherein
the first proppant particles have a particle size of about 0.2 mm to about 10 mm,
the second proppant particles have a particle size of about 0.010 μm to about 199 μm, and
in the subterranean formation at least part of at least one of the first and second proppant particles comprise electroconductive proppant particles;
transmitting at least one of an electric current and an electromagnetic signal to at least part of the electroconductive proppant particles; and
detecting at least one of an electric current and an electromagnetic signal at least partially reflected by or conducted through at least some of the electroconductive proppant particles.

58. The method of claim 57, wherein placing the first and second proppant particles in the subterranean formation comprises placing the first and second proppant particles in a subterranean fracture network.

59. The method of claim 57, wherein placing the first proppant particles in the subterranean formation comprises placing the first proppant particles into at least one of primary fractures and main branches of a fracture network.

60. The method of claim 57, wherein placing the second proppant particles in the subterranean formation comprises placing the second proppant particles into microfractures.

61. The method of claim 57, wherein placing at least one of the first and second proppant particles in the subterranean formation comprises forming an electroconductive proppant pack that comprises the electroconductive proppant particles.

62. The method of claim 57, further comprising fracturing the subterranean formation.

63. The method of claim 57, wherein the placing of at least one of the first and second proppant particles in the subterranean formation comprises fracturing at least part of the subterranean formation to form at least one subterranean fracture.

64. The method of claim 57, wherein the electroconductive proppant particles comprise at least some of the first proppant particles.

65. The method of claim 57, wherein the electroconductive proppant particles are formed in the subterranean formation from at least one of the first and second proppant particles.

66. The method of claim 57, wherein the electroconductive proppant particles are electroconductive proppant particles prior to placement in the subterranean formation.

67. The method of claim 57, wherein the electroconductive proppant particles comprises at least some of the second proppant particles.

68. The method of claim 57, wherein the electroconductive particles at least some of the first proppant particles and at least some of the second proppant particles.

69. The method of claim 57, wherein the electroconductive proppant particles comprise an electroconductive coating comprising a resin and an electroconductive material.

70. The method of claim 57, wherein the first and second proppant particles comprise particles comprising a first electroconductive coating and particles comprising a second electroconductive coating, wherein the first electroconductive coating and the second electroconductive coating have different conductivities.

71. The method of claim 57, wherein the method further comprises coating at least one fracture in the subterranean formation with an electroconductive coating.

72. The method of claim 57, further comprising using the detected reflected or conducted electric current or electromagnetic signal to determine at least one characteristic of a fracture network or a fracture thereof in the subterranean formation comprising at least one of height, width, length, orientation, geometry, layout, conductivity, proppant conductivity, and distribution of proppant.

73. The method of claim 57, wherein the transmitting of the electrical current comprises transmitting the electrical current from at least one electrode and the receiving of the electric signal comprises receiving by at least one electrode.

74. The method of claim 57, wherein the transmitting of the electromagnetic signal comprises transmitting from a radar assembly and the receiving of the electromagnetic signal comprises receiving by a radar assembly.

75. A method of obtaining data from a subterranean formation, the method comprising:
placing the first and second proppant particles into a fracture network in a subterranean formation, wherein
the first proppant particles have a particle size of about 0.2 mm to about 10 mm,
the second proppant particles have a particle size of about 0.010 μm to about 199 μm, and
the first proppant particles are placed in the fracture network in primary fractures or in main fracture branches having a smallest cross-sectional dimension of greater than about 0.2 mm and the second proppant particles are placed in the fracture network in microfractures having a smallest cross-sectional dimension of less than about 200 μm, wherein at least the second proppant particles in the subterranean formation comprise electroconductive proppant particles comprising an electroconductive coating comprising a resin and an electroconductive material;
transmitting at least one of an electric current and an electromagnetic field to at least part of the electroconductive proppant particles; and
detecting at least one of an electric current and an electromagnetic signal at least partially reflected by or conducted through the electroconductive proppant particles, and using the detected reflected or conducted electric current or electromagnetic signal to determine at least one characteristic of the fracture network or a fracture therein comprising at least one of height, width, length, fracture orientation, geometry, layout, conductivity, proppant conductivity, and distribution of proppant.

76. A system for obtaining data from a subterranean formation, the system comprising:
first proppant particles and second proppant particles, wherein
the first proppant particles have a particle size of about 0.2 mm to about 10 mm,
the second proppant particles have a particle size of about 0.010 μm to about 199 μm, and
at least part of at least one of the first and second proppant particles comprise electroconductive proppant particles;
a subterranean formation comprising the first and second proppant particles therein;
a transmitter configured to transmit at least one of an electric current and an electromagnetic field into at least part of the electroconductive proppant particles; and
a detector configured to detect at least one of an electric current and an electromagnetic signal at least partially reflected by or conducted through at least some of the electroconductive proppant particles.
